(19) United States
(12) Patent Application Publication
(10) Pub. No.: US 2012/0273555 A1
(43) Pub. Date: Nov. 1, 2012

(54) FRICTION STIRRING AND ITS APPLICATION TO DRILL BITS, OIL FIELD AND MINING TOOLS, AND COMPONENTS IN OTHER INDUSTRIAL APPLICATIONS

(75) Inventors: Richard August Flak, Springville, UT (US); Scott M. Packer, Alpine, UT (US); Russell J. Steel, Salem, UT (US); Monte E. Russell, Orem, UT (US); Brian E. Taylor, Draper, UT (US)

(73) Assignee: MEGASTIR TECHNOLOGIES LLC, Provo, UT (US)

(21) Appl. No.: 13/281,868

(22) Filed: Oct. 26, 2011

Related U.S. Application Data
(62) Division of application No. 11/136,609, filed on May 23, 2005, now abandoned.
(60) Provisional application No. 60/573,707, filed on May 21, 2004.
(60) Provisional application No. 60/637,223, filed on Dec. 17, 2004.
(60) Provisional application No. 60/652,808, filed on Feb. 14, 2005.

(51) Int. Cl. B23K 20/12; B32B 37/06

(52) U.S. Cl. 228/112.1

(57) ABSTRACT

Solid state processing is performed on a workpiece that operates alone or is a component of equipment used in various demanding, harsh and wearing environments in which failure of a product could compromise safety or the environment or otherwise result in significant cost for repair or replacement, wherein the solid state processing performed by using a tool capable of friction stir processing, friction stir mixing, or friction stir welding results in a workpiece that offers a longer life-cycle and/or improved performance and/or improved reliability as a result of the solid state processing.

### CROSS REFERENCE TO RELATED APPLICATIONS

This document claims priority to and incorporates by reference all of the subject matter included in the provisional patent applications having docket number 3043.SMII.PR with Ser. No. 60/573,707 and filed May 21, 2004, docket number 3208.SMII.PR with Ser. No. 60/637,223 and filed Dec. 17, 2004, and docket number 3213.SMII.PR with Ser. No. 60/652,808 and filed Feb. 14, 2005, and to non-provisional applications having docket number 3212.SMII.NP with Ser. No. 11/090,909 and filed Mar. 24, 2005, docket number, and docket number 3284.SMII.NP with Ser. No. 11/090,317 and filed Mar. 24, 2005.

### BACKGROUND OF THE INVENTION

1. Field of the Invention

This invention relates generally to solid state processing of materials through friction stirring, which includes friction stir processing, friction stir mixing, and friction stir welding. This invention also relates to the application of the friction stir processes to the manufacturing of drill bits, oil field and mining equipment and tools, and components or parts used in other industrial and medical applications.

2. Background of the Invention

Friction stir welding (hereinafter “FSW”) is a technology that has been developed for welding metals and metal alloys. The FSW process often involves engaging the material of two adjoining workpieces on either side of a joint by a rotating stir pin or spindle. Force is exerted to urge the spindle and the workpieces together and frictional heating caused by interaction between the spindle and the workpieces results in plasticization of the material on either side of the joint. The spindle is traversed along the joint, plasticizing material as it advances, and the plasticized material left in the wake of the advancing spindle cools to form a weld.

FIG. 1 is a perspective view of a tool being used for friction stir welding that is characterized by a generally cylindrical tool 10 having a shoulder 12 and a pin 14 extending outward from the shoulder. The pin 14 is rotated against a workpiece 16 until sufficient heat is generated, at which point the pin of the tool is plunged into the plasticized workpiece material. The workpiece 16 is often two sheets or plates of material that are butted together at a joint line 18 but could also be cylindrical or other non-flat materials or surfaces. The pin 14 is plunged into the workpiece 16 at the joint line 18.

The frictional heat caused by rotational motion of the pin 14 against the workpiece material 16 causes the workpiece material to soften, preferably without reaching a melting point of the workpiece material. The tool 10 is moved transversely along the joint line 18, thereby creating a weld as the plasticized material flows around the pin from a leading edge to a trailing edge. The result is a solid phase bond 20 at the joint line 18 that may be generally indistinguishable from the workpiece material 16 itself, in comparison to other welds. However, it has been discovered that the solid phase bond 20 may be created to also have different and advantageous properties as compared to the original workpiece material 16.

It is observed that when the shoulder 12 contacts the surface of the workpieces, its rotation creates additional frictional heat that plasticizes a larger cylindrical column of material around the inserted pin 14. The shoulder 12 provides a forging force that contains and/or forces downward the generally upward metal flow caused by the tool pin 14.

During FSW, the area to be welded and the tool are moved relative to each other such that the tool traverses a desired length of the weld joint. The rotating FSW tool provides a continual hot working action, plasticizing metal within a narrow zone as it moves transversely along the base metal, while transporting metal from the leading face of the pin to its trailing edge. As the weld zone cools, there is typically no solidification as no liquid is created as the tool passes. It is often the case, but not always, that the resulting weld is a defect-free, recrystallized, fine grain microstructure formed in the area of the weld.

Travel speeds of the pin 14 along the joint line 18 are typically around 10 to 500 mm/min with rotation rates of 200 to 2000 rpm. However, operating parameters outside of this range may also be used. Temperatures reached in FSW are usually close to, but below, solidus temperatures of the base materials. Friction stir welding parameters are a function of a material's thermal properties, high temperature flow stress and penetration depth.

Friction stir welding has several advantages over fusion welding because 1) filler metal is not required, 2) the process can be fully automated requiring a relatively low operator skill level, 3) the energy input is efficient as all heating occurs at the tool/workpiece interface, 4) minimum post-weld inspection is required due to the solid state nature and extreme repeatability of FSW, 5) FSW is tolerant to interface gaps and as such little pre-weld preparation is required, 6) there is no weld spatter to remove, 7) the post-weld surface finish can be exceptionally smooth with little to no flash, 8) there is little or no porosity and oxygen contamination, 9) there is little or no distortion or surrounding material, 10) minimal operator protection is required as there are no harmful emissions, and 11) weld properties are improved.

Previous patent documents have taught the benefits of being able to perform friction stir welding with materials that were previously considered to be functionally unweldable. Some of these materials are non-fusion weldable, or just difficult to weld at all. These materials include, for example, metal matrix composites, ferrous alloys such as steel and stainless steel, and non-ferrous materials. Another class of materials that were also able to take advantage of friction stir welding is the superalloys. Superalloys can be materials having a higher melting temperature than bronze or aluminum, and may have other elements mixed in as well. Some examples of superalloys are nickel, iron-nickel, and cobalt-based alloys generally suitable for use at temperatures above 1000 degrees F. Additional elements commonly found in superalloys include, but are not limited to, chromium, molybdenum, tungsten, aluminum, titanium, niobium, tantalum, and rhenium.

It is noted that titanium is also a desirable material to friction stir weld. Titanium is a non-ferrous material, but has a higher melting point than other nonferrous materials.

Those skilled in the art have previously taught that a tool is needed that is formed using a material that has a higher melting temperature than the material being friction stir welded. In some embodiments, a superabrasive was used in the tool.

The embodiments of the present invention are generally concerned with these functionally unweldable materials, as well as the superalloys, and are hereinafter referred to as “high melting temperature” materials throughout this document. It is noted that the principles of the present invention are also equally applicable to materials that are considered lower melting temperature or functionally weldable materials.

In line with friction stir welding, the inventors have determined that new and advantageous properties can also be obtained by performing friction stir processing and friction stir mixing (see for example the application having Ser. No. 11/090,910 and filed Mar. 24, 2005). Friction stir processing is a solid state process created by friction that uses a tool not to join materials together in welding, but to instead condition or treat the surface or all of a material by running the tool through at least a portion of the material being processed.

Friction stir mixing is similar to friction stir processing as described above, but combines with it the aspect of mixing in one or more different materials into a base material or workpiece to create a new material having advantageous characteristics as compared to the original base material.

### Liquid State Processing of Materials

The periodic table outlines and organizes the elements that are used to engineer all of the materials developed and produced today. Each of these elements can exist in solid, liquid, or gaseous states depending on temperature and pressure. Solid materials created from these elements such as metallic ferrous alloys, metallic nonferrous alloys, metal matrix composites, intermetallics, cermets, cemented carbides, polymers, and others undergo specific processing to create the material's desired physical and mechanical properties.

Each of the previously named solid material types was created by mixing the elements together in some fashion and applying heat and/or pressure so that a liquid and/or liquid-solid mixture is formed. The mixture is then cooled to form the resulting solid material. The solid material formed will have a characteristic microscopic crystalline or granular structure that reveals some of the processing characteristics, phases of element mixtures, grain orientation, etc. For example, mild steel is made by mixing specified amounts of carbon and iron together (along with trace elements) and heating the mixture until a liquid is formed. As the liquid cools and solidifies, steel is formed.

Cooling rates, subsequent heat treatments and mechanical processing will affect the microstructure of the steel and its resulting properties. The microstructure reveals a granular structure having an average specific grain size and shape. Many decades of research and engineering have been dedicated to understanding and creating different materials from a variety of elements using temperature and mechanical processing to create desired material and mechanical properties.

Engineered materials such as metallic ferrous alloys, metallic nonferrous alloys, metal matrix composites, intermetallics, cermets, cemented carbides and others all require a process that melts some or all of the elements together to form a solid. However, there are several problems that occur as a result of having this liquid to solid phase transformation.

For example, during the liquid phase, the time at temperature and/or pressure often becomes a critical variable. Some elements dissolve into submixtures while others precipitate out as they are combined with other elements to form new phases. This dynamic behavior is a complex interaction of elemental solubility, diffusion characteristics, and thermodynamic behavior. Because of these complexities, it is difficult to engineer a material from the beginning. The material is instead developed through trial and error experimentation. Even when a specific elemental composition is determined, the liquid phase processing can have a multitude of process parameters that will alter the resulting solid material's properties. During this liquid phase, time, temperature and pressure play a critical role in determining the material's characteristics. The more elements combined in the mixture, the more difficult liquid phase processing becomes to produce a predictable material.

As the mixture solidifies, undesirable phases precipitate into the solid structure, detrimental dendritic structures can form, grain size gradients are created from temperature gradients, and residual stresses are induced which in turn cause distortions or undesirable characteristics in the resulting material. Solidification defects such as cracking and porosity are constant problems that plague the processing of materials formed from a prior liquid phase. All of these problems combine to lower a given material's mechanical and material properties. Unpredictability in a material's properties results in unpredictability in a component's reliability that is made from such materials.

Because of these solidification problems and resulting defects, additional mechanical and thermal processes are often performed in order to bring back some of the material's desirable properties. These processes include forging, hot rolling, cold rolling, and extrusion to name a few. Unfortunately, mechanical processes often give the material undesired directional properties, reduce ductility, add incremental residual stresses and increase cost. Heat treatments can be used to relieve residual stresses, but even these treatments can cause grains to grow and other distortions to occur.

It is often the case that the bulk size of materials being processed prohibits shorter processing times needed to prevent grain growth. The thermal capacitance of these large bulk materials also maintains elevated temperatures for extended periods of time which by itself also creates an environment for detrimental prolific grain growth. Unfortunately, quickly dropping the temperature of the bulk material through quenching is again problematic because cracking and residual stresses that approach the tensile strength of the material can be formed.

Thus it should be apparent why it is so difficult to design and produce a material with a given grain size, grain size distribution and elemental composition that has a desired range of properties when it is necessary to use a liquid phase mixture to create the solid material.

For example, manufacturers of many materials desire to produce very fine grain (sub-micron) microstructures to obtain the highest possible material and mechanical properties possible. Presently, fine grain microstructures are achieved with the addition of grain growth inhibiting elements or mixtures to the liquid phase of the processing. While reducing grain size, these inhibitors often cause other material processing problems. Some of these problems include lower strength of the material, grain boundary defects, and detrimental phases.

### High Temperature Friction Stir Welding Tool

In conjunction with the problems associated with the creation of materials that require liquid to solid phase transformation, recent advancements in friction stir welding technologies has resulted in tools that can be used to join high melting temperature materials such as steel and stainless steel together during the solid state joining processes of friction stir welding.

This technology involves using special friction stir welding tools capable of withstand higher operating temperatures. FIG. 2 shows one example of a friction stir welding tool that can be used in high temperature applications. In this example, the tool comprises a polycrystalline cubic boron nitride (PCBN) tip 30, a locking collar 32, a thermocouple set screw 34 to prevent movement, and a shank 36.

When this tool is used it is effective at friction stir welding of various materials. This tool design is also effective when using a variety of tool tip materials besides PCBN. Other materials that may be used include and PCD (polycrystalline diamond) and refractories such as tungsten, rhenium, iridium, titanium, molybdenum, etc.

Because these tip materials are often expensive to produce, a design having a replaceable tip is an economical way of producing and providing tools to the market because they can be replaced when worn or fractured.

### Applications Requiring Durable Higher Melting Temperature Materials

Many applications require the use of durable and/or higher melting temperature materials. These applications include, but are not limited to: oil and gas exploration, development, recovery, transportation, storage and processing; mining; construction; petrochemical; defense; and other industrial applications. For example, in oil and gas exploration and production, products and engineering services that include the use of durably higher melting temperature materials include drilling and completion fluid systems, solids-control equipment, waste-management services, production chemicals, three-cone and fixed cutter drill bits, turbines, drilling tools, under reamers, casing exit and multilateral systems, packers and liner hangers, to name a few.

Products and services in the industries described above typically require equipment and tools that must operate in harsh or demanding environments. While the wearing down or failure of parts and components is an expected reality, tremendous benefits may be obtained if the life of parts and components can be extended and/or their performance or reliability improved. For example, in oil and gas exploration consider a roller cone drill bit connected to the distal end of a drill string to drill a well bore that may span a mile or more in length underground. When a bit component, such as the seals or bearings fail, the entire drill string must be extracted to retrieve and replace the bit. This can result in a significant cost to a drilling operation because of the ancillary equipment, manpower, and time required retrieving and replacing the bit. Thus, a significant benefit can be obtained by providing or using a bit having longer lasting components.

In general, methods and techniques that can be used to produce parts, components, tools, and/or equipment having an increased life-cycle and/or improved performance and/or reliability are greatly desired in these and other applications.

### BRIEF SUMMARY OF THE INVENTION

It is one aspect of the present invention to provide a system and method for friction stirring of a material in order to obtain beneficial microstructures.

It is another aspect to provide a system and method for friction stirring in order to obtain beneficial macrostructures.

It is another aspect to provide a system and method for friction stirring to improve toughness of a workpiece.

It is another aspect to provide a system and method for friction stirring to increase or decrease hardness of a workpiece.

It is another aspect to provide a system and method for friction stirring to modify targeted areas of a workpiece.

It is another aspect to provide a system and method for friction stirring to modify a workpiece such that different areas of the same workpiece are modified to have different properties.

It is another aspect to provide a system and method for friction stirring to modify the surface of a workpiece.

It is another aspect to provide a system and method for friction stirring to modify the surface and at least a portion of the interior of the workpiece.

It is another aspect to provide a system and method for friction stirring that only modifies portions of a workpiece while leaving other portions that are not modified.

In various embodiments of the present invention, solid state processing is performed on a workpiece that operates alone or is a component of equipment used in various demanding, harsh and wearing environments in which failure of a product could compromise safety or the environment or otherwise result in significant cost for repair or replacement, wherein the solid state processing performed by using a tool capable of friction stir processing, friction stir mixing, or friction stir welding results in a workpiece that offers a longer life-cycle and/or improved performance and/or improved reliability as a result of the solid state processing, wherein solid state processing modifies characteristics of a workpiece, and wherein modified characteristics of the material include, but are not limited to, microstructure, macrostructure, toughness, hardness, grain boundaries, grain size, impact resistance, ballistic properties, the distribution of phases, ductility, superplasticity, change in nucleation site densities, compressibility, expandability, coefficient of friction, abrasion resistance, corrosion resistance, fatigue resistance, magnetic properties, strength, radiation absorption, and thermal conductivity.

These and other aspects, features, advantages of the present invention will become apparent to those skilled in the art from a consideration of the following detailed description taken in combination with the accompanying drawings.

### BRIEF DESCRIPTION OF THE DRAWINGS

FIG. 1 is a perspective view of a tool as taught in the prior art for friction stir welding, wherein the tool can be used to perform a new function.

FIG. 2 is a perspective view of a removable polycrystalline cubic boron nitride (PCBN) tip, a locking collar and a shank.

FIG. 3 is one embodiment of a friction stir processing tool having a shoulder and shank of equal diameter.

FIG. 4 is a cross-sectional view of a base material that is friction stir processed to modify the characteristics of the base material.

FIG. 5 is a view of the microstructure of the base material before friction stir processing.

FIG. 6 is a view of the microstructure of the base material after friction stir processing.

FIG. 7A is a graph of a hardness gradient of the friction stir processed material.

FIG. 7B is a graph of a hardness gradient where heat treatment has been performed in addition to friction stir processing.

FIG. 8 is a cross-sectional view of a base material that is friction stir processed to modify the characteristics of the base material, and having an overlay identifying where a cutting edge could be formed from the friction stir processed material.

FIG. 9 is an illustration of the microstructure that shows large grain size of the annealed condition of the material.

FIG. 10 is a cross-sectional view of material that has been friction stir mixed so as to include another material.

FIG. 11 is a cross-sectional view of the microstructure of the steel of FIG. 10.

FIG. 12 is a cross-sectional view of one embodiment for friction stir mixing an additive material into another using a mesh or screen to hold the additive material in place.

FIG. 13 is a cross-sectional illustration of the results of friction stir mixing tungsten carbide in the form of a powder into steel.

FIG. 14 is a planar view of the microstructure of the surface of the region where the steel 120 and the tungsten carbide power are mixed.

FIG. 15 is a table of how material characteristics can be affected through friction stirring.

FIGS. 16 through 84 are illustrations of equipment, or components for equipment that will benefit from friction stirring of particular areas of the equipment or components.

FIG. 85 is a cut-away illustration of the seal gland area of the journal and steel roller cone bit.

FIG. 86 is a perspective view of a mill tooth roller cone bit.

### DETAILED DESCRIPTION OF THE INVENTION

Reference will now be made to the drawings in which the various aspects, elements, and embodiments of the present invention will be discussed so as to enable one skilled in the art to make and use the embodiments. It is to be understood that the following description is only exemplary of the principles of the present invention, and should not be viewed as narrowing the claims which follow.

In one aspect, the present invention as explained hereinafter will apply to several different classes of materials. In one or more embodiment, the materials may be considered to be those materials that have melting temperatures higher than bronze and aluminum as previously disclosed, and are referred to as “higher melting temperature materials”. This class of materials includes, but is not limited to, metal matrix composites, ferrous alloys such as steel and stainless steel, non-ferrous materials, superalloys, titanium, cobalt alloys typically used for hard-facing, and air hardened or high speed steels. In other embodiments, the materials may be considered to be all other lower melting temperature materials that are not included within the definition of the higher melting temperature materials described above.

### Solid State Processing

In accordance with aspects of the present invention, a solid state processing and a solid state joining method may be used in the manufacture of drill bits, oil field tools, or tools or equipment for industrial application or components thereof to yield improved material and mechanical properties for these applications. It is noted that friction stir processing and joining may be exclusive events of each other, or they may take place simultaneously. It is also noted that solid state processing in accordance with aspects of the present invention may also be referred to interchangeably with the phrase “friction stirring”. Solid state processing is defined herein as a temporary transformation into a plasticized state that typically does not include a liquid phase. However, it is noted that in some embodiments, one or more elements may be allowed to pass into a liquid phase, and still obtain benefits noted for embodiments of the present invention.

The benefits of solid state joining became apparent with the development of friction stir welding when two or more materials were joined together. In addition, it was observed that friction stir processing and friction stir mixing can be used to materially alter the properties of materials.

In accordance with one aspect of the present invention, friction stirring technology is applied to components or parts of drill bits, oil field tools, or other equipment and tools which may operate in high wear, high stress, high pressure, corrosive, radioactive, and/or otherwise harsh environments. In some embodiments, the components may be difficult to reach time-consuming to extract and/or replace when worn or damaged, or may be used in environments where failure is not considered an acceptable option, such as a blow out preventor.

The use of friction stirring for components in these applications makes it possible to engineer materials for these harsh or demanding environments that have modified microstructures that improve the life-cycle, performance or reliability of the materials or components used. Aspects of the present invention described herein may be applied to both lower melting temperature and higher melting temperature materials and alloys.

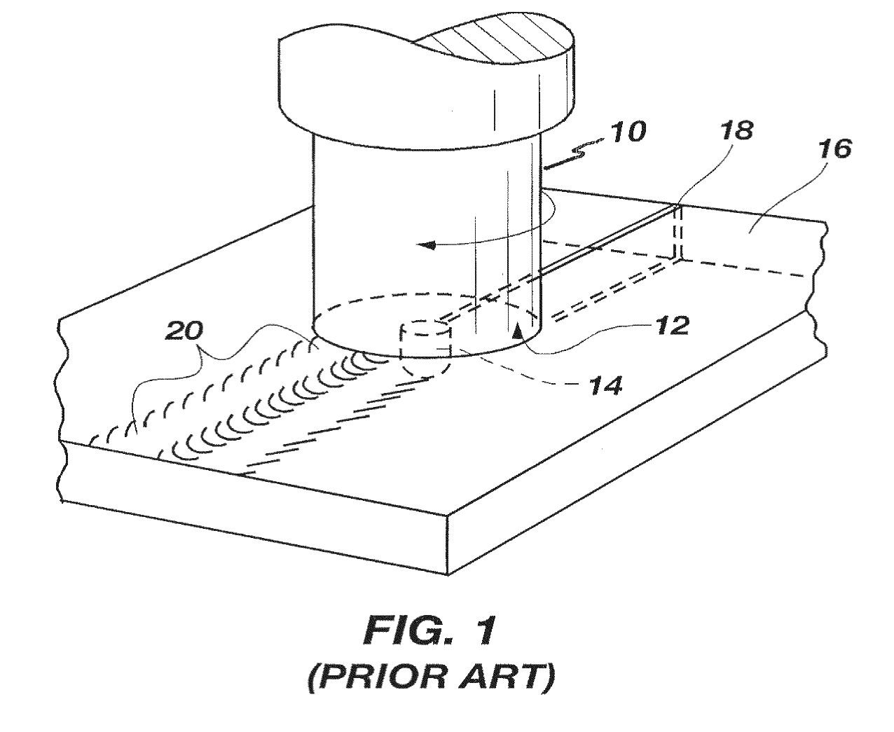

Tools that may be used in accordance with one or more embodiments of the present invention for performing desired friction stirring, have been described in previous documents, including documents incorporated herein by reference. In a brief explanation, friction stirring may be performed using the tool shown in FIG. 1. The friction stirring tool shown in FIG. 1 includes a shank, a shoulder, and a pin. In one or more embodiments, the tool pin is rotated and plunged into the material to be processed and moved transversely across an area of the component being processed, thereby causing the material to undergo plasticization in a solid state process. This results in the material being modified to have properties that are different from the original material.

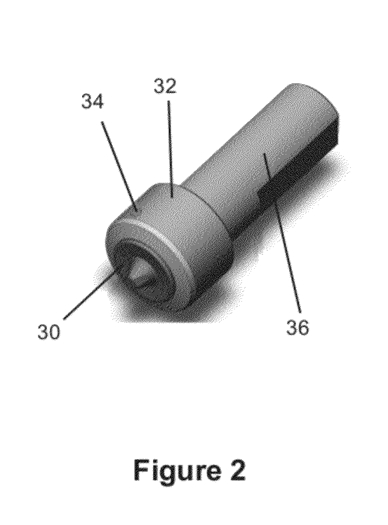

In another embodiment, a tool as shown in FIG. 2 may be used in the assembly of components or tools as an alternative to traditional prior art joining techniques to provide enhanced material or mechanical properties around the joint interface or to enhance the performance or reliability of the component or tool compared to that obtained using prior art joining techniques.

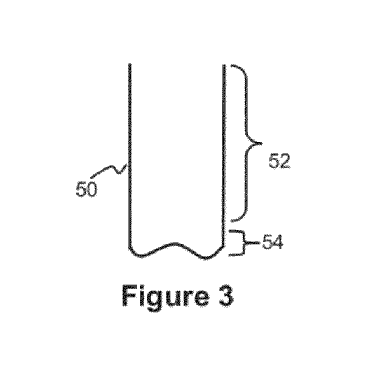

In other embodiments, a tool as shown in FIG. 3 can be used to perform friction stirring. FIG. 3 is a cross-sectional view of a cylindrical friction stirring tool 50. The friction stirring tool 50 has a shank 52 and a shoulder 54, but no pin. Therefore, instead of plunging a pin into the material to be solid state processed, the shoulder is pressed against the material. Penetration of the shoulder is typically limited to the surface region of the material or just below it because of the larger surface area of the shoulder as compared to the pin.

It should be noted that while the pin 14 of the tool 10 in FIG. 1 does not have to be plunged into the material, the pin may be designed for easy penetration. Thus, because the pin 14 is more likely to have a very small surface area as compared to the tool 50 of FIG. 3, the pin is more likely to plunge into the material. However, in some cases it may be advantageous to use the smaller surface area of the pin 14 for processing smaller areas of a material, which may be limited to the surface thereof. In one or more embodiments of the present invention, surface and near-surface processing may be used to achieve desired material properties for materials or components used in harsh or demanding environments.

Experimental results have shown that in selected embodiments, material being processed may undergo several changes during friction stirring. These changes can include, but should not be considered limited to, the following: toughness, hardness, grain boundaries, grain size, distribution of phases, ductility, superplasticity, change in nucleation site densities, compressibility, expandability, friction, and thermal conductivity.

Regarding nucleation, in one or more embodiments, observations indicate that there may be more nucleation sites due to the energy induced into the material from the heat and deformation generated during friction stir processing. Accordingly, more of the solute material may be able to come out of solution or precipitate to form higher densities of precipitates or second phases.

As an example, the following figures illustrate cross-sections of material that has undergone friction stirring through the plunging of a tool into the material. While observing the figures, it should be understood that similar or identical results can be obtained on smaller scales if the tool is not plunged into the material being processed.

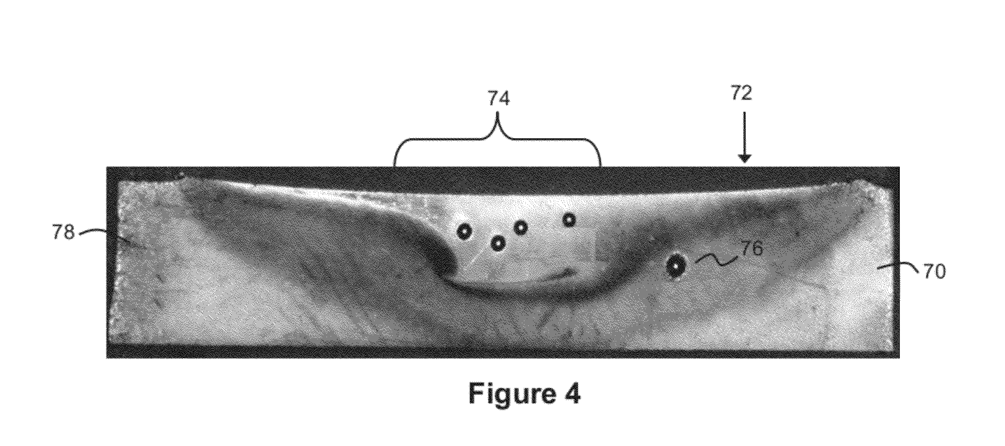

In FIG. 4, a section of ATS 34 steel was friction stir processed by plunging a tool similar to the tool shown in FIG. 2 into the base material 70 and moving the tool transversely along a middle length thereof. Transverse movement would be perpendicular to the page, thus FIG. 4 is a cross-sectional view of the base material 70.

FIG. 4 shows that the tool plunged into the base material 70 from the top 72. Several areas appearing as small circles are shown as having been tested for hardness relative to the Rockwell scale in the various zones of the base material. The stir zone 74 is shown having a hardness of 60 RC. Close to the boundary of the inner TMAZ (thermally mechanically affected zone) and the outer HAZ (heat affected zone) the base material 70 is shown as having a hardness value of 44 RC at a location 76. Finally, an unprocessed or original base material zone is shown as having retained, in other samples, its original hardness value of 12 RC at approximately location 78.

FIG. 5 is provided to illustrate the microstructure of a processed base material 80. The figure shows that friction stir processing has created Martensite indicating the harder phase of the processed base material 80.

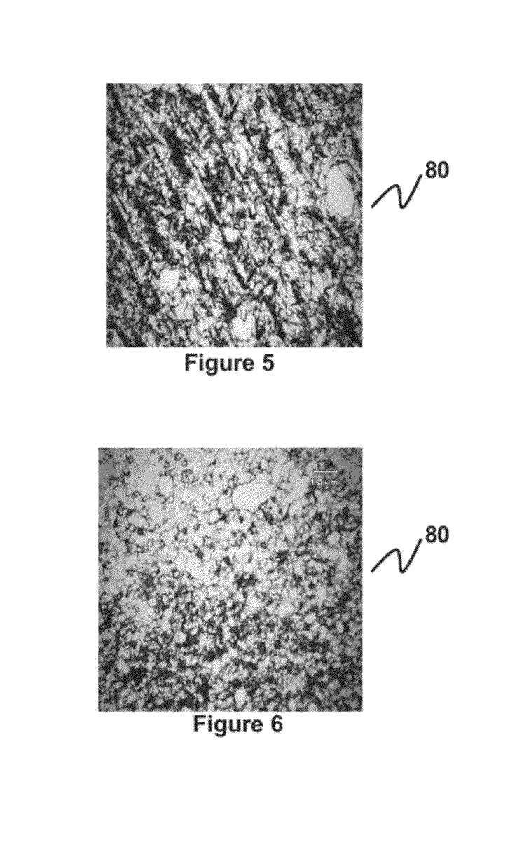

Similarly, FIG. 6 is also an illustration of the microstructure of the material 80 after it has been friction stir processed. The figure shows the reduced grain size in the processed base material 80.

For purposes of comparison, heat treatment of the base material 70 of FIG. 5 would typically result in a hardness value less than 60 RC. In some embodiments of the present invention, it is possible to selectively friction stir process large portions of the base material 70 that are otherwise difficult to do with other heat treatment methods. In addition, a material designer can be more selective in the areas of the material that are to receive processing. Furthermore, although heat treatment will alter the microstructure of the material, the changes will not be the same type of changes that can be achieved with friction stir processing. For example, the processed area has also experienced a substantial increase in toughness. This is notable because there is typically a tradeoff between toughness and hardness when processing materials using conventional treatment techniques.

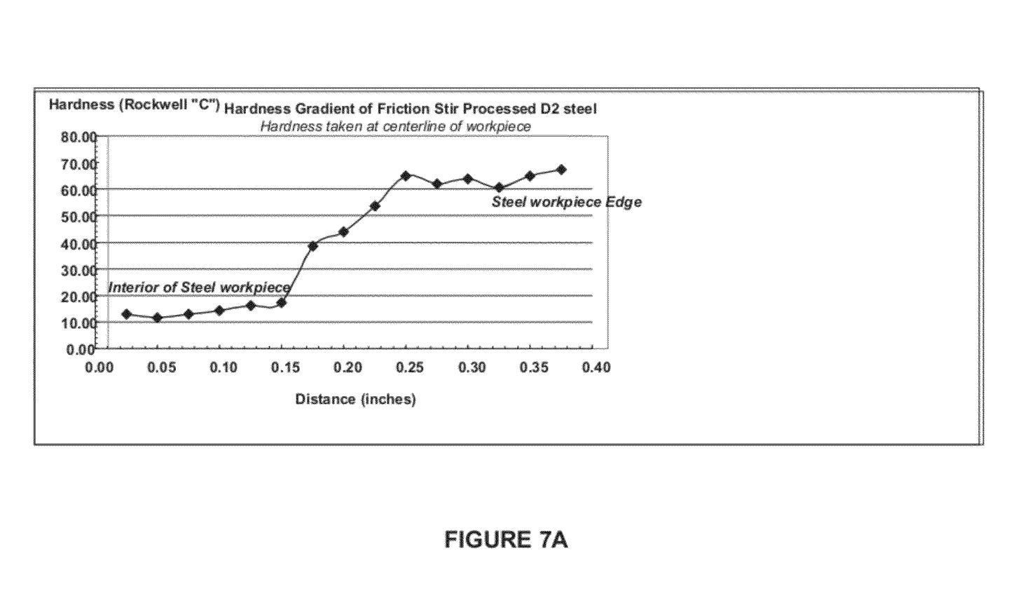

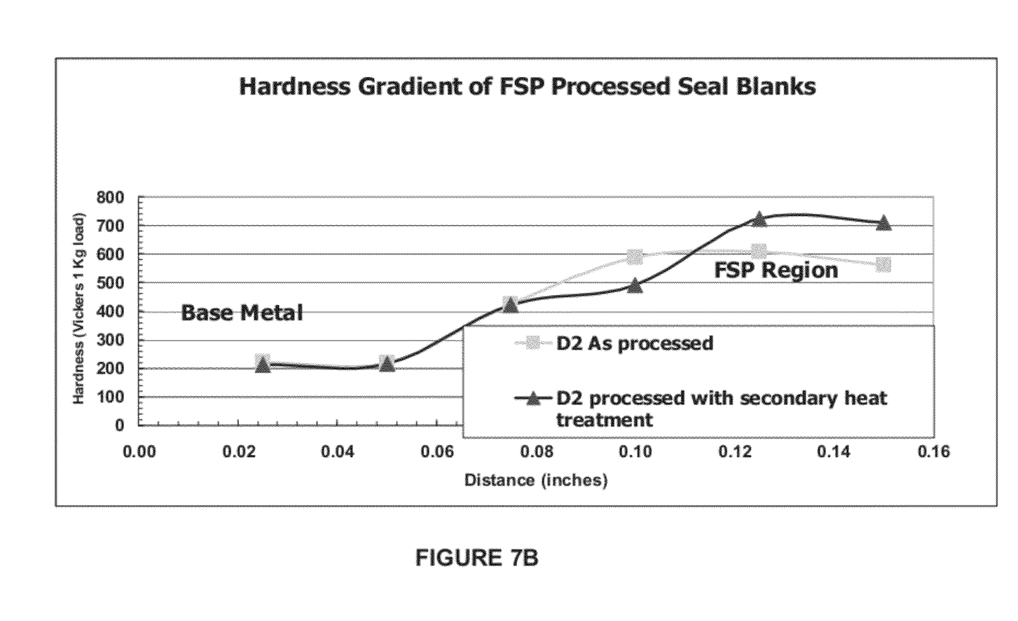

In another embodiment, a member formed of D2 steel was friction stir processed along one edge thereof. After processing the edge, the hardness across the width of the member from an interior unprocessed region to the processed region was determined. The hardness gradient in the material that is a result of the friction stir processing is illustrated in the graph of FIG. 7A. In this example, the friction stir processing resulted in a significant improvement in the hardness characteristics of the material in the friction stir zone along with an improvement in toughness.

Further experimentation resulted in a D2 sample workpiece that had the hardness gradient characteristics as described in FIG. 7B. However, further secondary heat treatments were performed to obtain an additional increase in hardness of the materials.

Friction stirring techniques in accordance with aspects of the present invention can be used to not only create durable materials, but materials that can be altered to perform better in very specific environments.

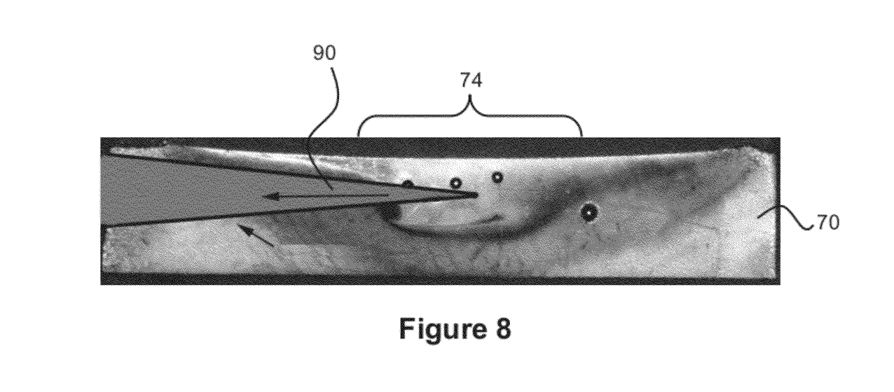

For example, FIG. 8 is an illustration of an overlay 90 of a cutting edge on the ATS-34 steel base material 70. The overlay 90 indicates one advantageous configuration of a cutting edge that could be machined from the material 70, wherein the configuration takes the greatest advantage of the improved toughness and hardness characteristics of the friction stir processed material 70. Note that the cutting edge overlay 90 is formed in the processed region 74 that will result in a hard and yet tough cutting edge. Likewise, any object being formed from a processed material can be arranged to provide the most advantageous properties where it is most critical for the object. In this example, a beneficial cutting edge will be achieved from having an edge disposed well within the processed material.

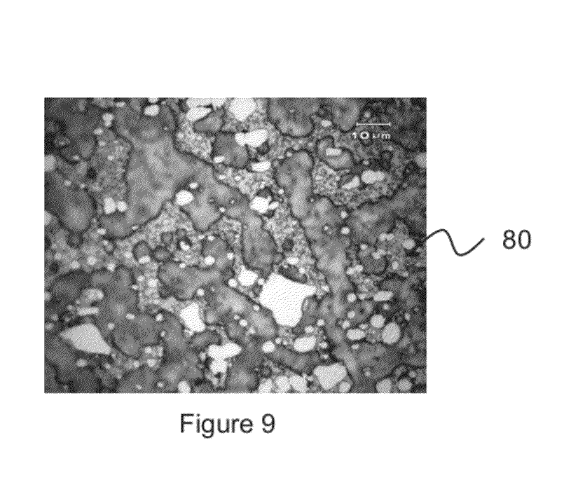

FIG. 9 is helpful for making comparisons between the microstructure of the processed base material 80 of FIGS. 6 and 7, and the unprocessed base material 80 shown here. The microstructure shows the large grain size of the annealed condition of the base material 80 before friction stir processing.

FIGS. 5 though 8 illustrate limited aspects of the present invention regarding friction stir processing.

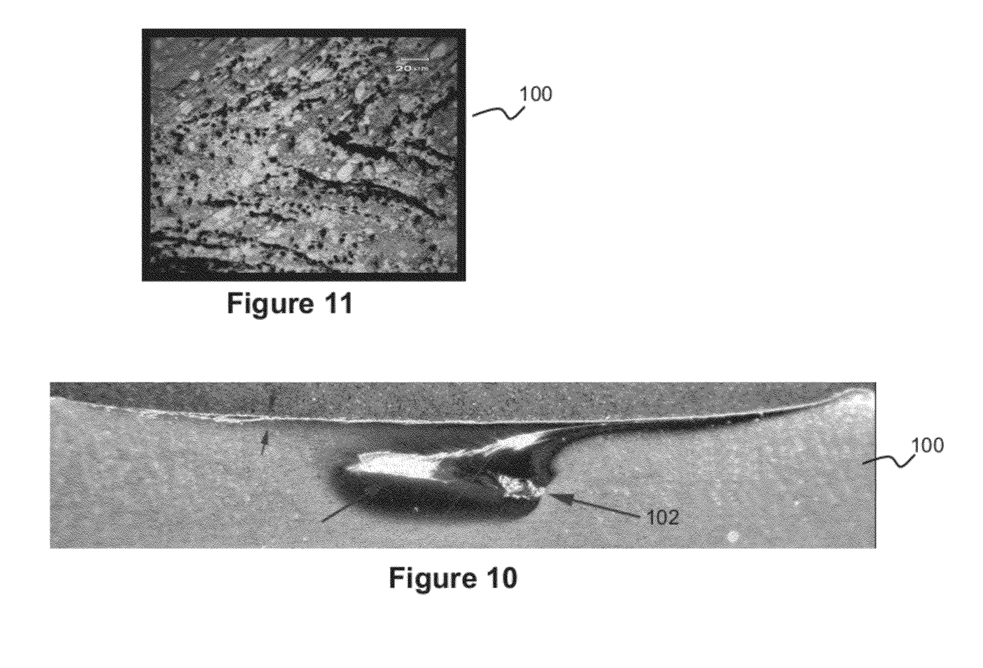

FIG. 10 is a cross-sectional view of a base material that has been friction stir mixed so as to include an additive material. In this example, a steel member 100 has been friction stir mixed so as to work in diamond particles 102 into the steel member.

FIG. 11 is a cross-sectional view of the microstructure of the steel member 100. The figure shows that the diamond particles 102 are present throughout the mixed region of the steel member 100.

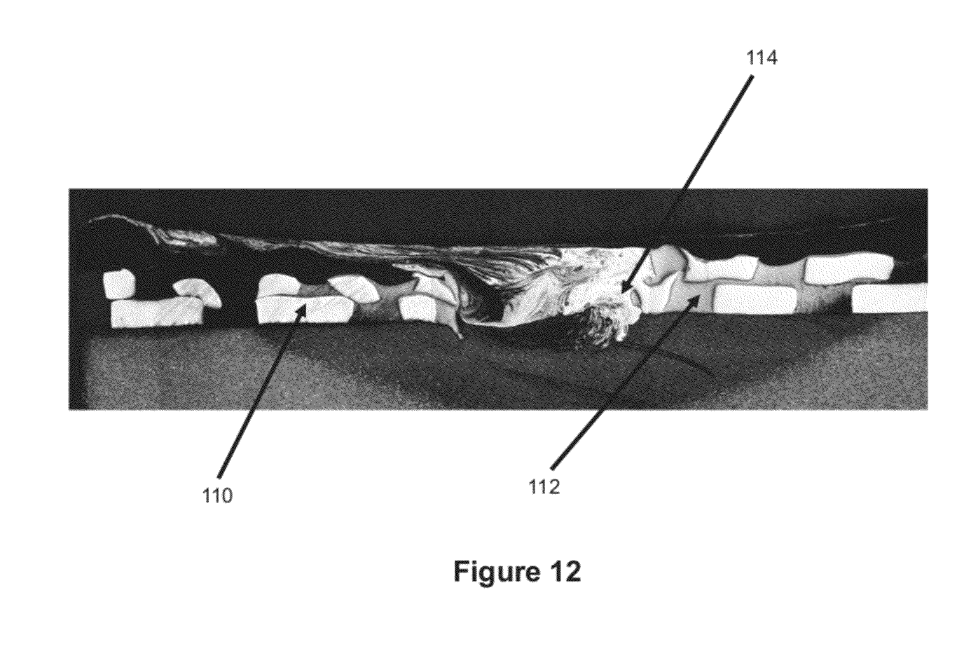

FIG. 12 is a cross-sectional view of one embodiment for friction stir mixing an additive material 112 into another using a mesh or screen 110 to hold the additive material 112 in place. Specifically, a stainless steel mesh or screen 110 is being used to hold carbide 112 in the form of a powder. The screen 110 and carbide powder 112 are disposed on the surface of a base material 114. The surface of the base material 114 is then friction stir processed, resulting in a mixing of the stainless steel 110, the carbide 112, and the base material 114 at the surface of the base material. Alternatively, the different materials could be mixed further into the base material 114 using a tool having a pin, or by using a tool having a shoulder that is pressed harder into the base material.

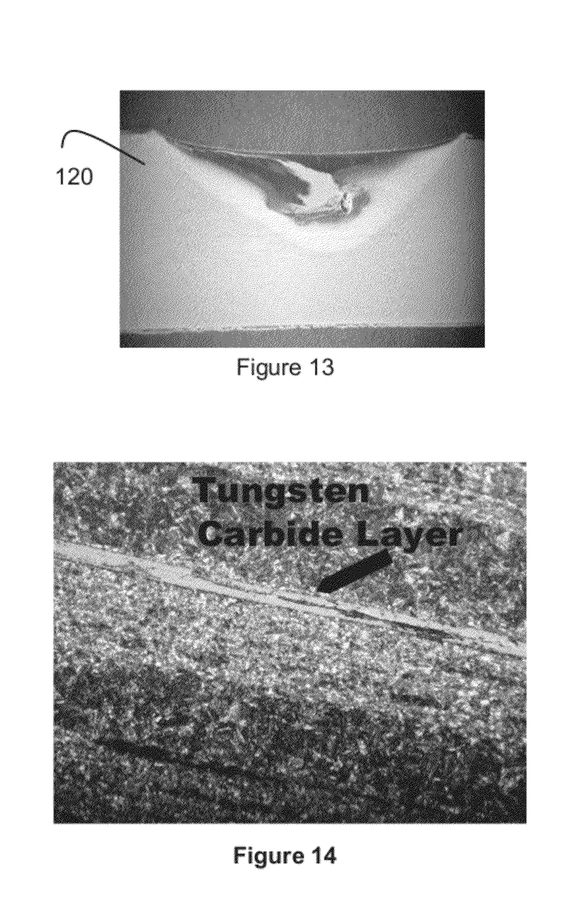

FIG. 13 is a cross-sectional illustration of the results of friction stir mixing tungsten carbide in the form of a powder into steel member 120.

FIG. 14 is a planar view of the microstructure of the surface of the region where the steel member 120 and the tungsten carbide power are mixed.

Another aspect of the present invention is the ability to both solid state process and join at the same time. Consider two workpieces being welded together. The workpieces could be the same material or different materials. By friction stir welding the workpieces together, the resulting material can have distinctly different properties in a weld region from those of the materials that are being joined together.

As shown in FIG. 12, the embodiment shows that it is possible to introduce another material into a base material for friction stir mixing. However, the present invention should not be considered to be limited to this one design. Some other methods of introducing an additive material include, but are not limited to, entrenching a packed powder into the surface of a workpiece, sandwiching a material between workpieces to be joined together, and even using adhesives to bind the additive to the workpiece until friction stir mixed together. The adhesive can be selected so that it burns away during the friction stir mixing process, thereby not affecting the resulting mixed materials. However, it should be realized that it may be desirable to include whatever material is being used to bind an additive to a base material.

Another method of introducing an additive is through the use of a consumable tool. For example, a pin or a shoulder may be comprised of a material that will erode away into the base material. Thus, the pin, a shoulder, or a portion of a shoulder is comprised of the additive material.

The present invention can also be considered as a new means for introducing energy into materials processing. Essentially, mechanical energy is being used in a solid state process to modify a material. The mechanical energy is in the form of the heat and deformation generated by the action of friction stir processing or friction stir mixing.

Another aspect of the present invention is the ability to modify and control residual surface and subsurface stress components in a processed material. In some embodiments, it is possible to introduce or increase compressive residual stress, while in other embodiments, undesirable stresses may be reduced.

Controlling residual stresses may be particularly important in some high melting temperature materials. Friction stir processing and friction stir mixing includes contacting a workpiece with a rotating (or otherwise moving) friction stir processing or friction stir mixing tool to thereby generate a solid state processing of the material to modify stress along a surface of the material. Stress reduction should not be considered to be limited only to the surface. In other embodiments, the aspect of modifying subsurface stress is also a part of the present invention.

Some embodiments also enable a user to control heating and cooling rates by exercising control over process parameters. Friction stir processing and mixing parameters include relative motion of the tool (e.g., rotation rate and translational movement rate of the tool), depth of tool penetration, the downward force being applied to the tool, cooling rates along with cooling media (water cooling), etc.

Regarding friction stir mixing, the nature of the additive material can also directly influence the nature of the resulting processed area. Powder and diamond particles were discussed above. In an alternative embodiment, the physical structure of the additive material may affect the resulting properties. For example, fibers or other types of elongated particles can be mixed into a base material in a zone inside as well as just outside of a mixing region. In addition, additive materials can be harder or softer than the base material or other additives.

All additive materials may be selected so as to control mechanical properties such as abrasion resistance, corrosion resistance, hardness, toughness, crack prevention, fatigue resistance, magnetic properties, and hydrogen embrittlement, among others, of the base material. For example, the hard particles will be held in place mechanically, or by solid state diffusion, with greater retention than cast structures since the strength of the mixing region may or may not be greater than in the base material.

Hard particles may include tungsten carbide, silicon carbide, aluminum oxide, cubic boron nitride, and/or diamond or any material harder than the base material that will not go fully into solution at the mixing temperature (usually 100 to 200 degrees C. above??? the melting point of the base material). In addition, fibers may be added in the same fashion to locally strengthen the base material or add directional properties.

Additive materials may be specifically selected for the ability to go into solution in order to achieve some specific characteristic of the processed base material. Additives can also enhance toughness, hardness, enhance thermal characteristics, etc.

Another advantage of putting additives into a base material is that particles or fibers can be selected from materials that cannot be used in fusion or hard facing processing because they would go into solution during a liquid phase of the base material. In friction stir processing, eutectic compositions of the particle/fiber with the base material can be avoided so that dual properties can be achieved. The introduction of the particle/fiber into the base material can be varied to tailor different properties within a given workpiece.

For example, a tool with a long pin can be used to stir particles/fibers to a deeper depth and then a second tool with a shorter pin can be used to stir a different particle/fiber at a different depth to form layered features in the base material. Geometry of a mixing region, particle/fiber composition, particle/fiber size, particle/fiber distribution and location within the base material can provide engineered wear and strength features to a given object.

A friction stir processing tool similar to the tool shown in FIG. 2 can be used to create new materials and modify existing materials. For example, elements in powder form can be placed in a mold. The tool 10 can be rotated and plunged into the powder to generate heat. As the tool 10 is traversed through the powder, solid state diffusion occurs to join the powder into a solid form with the base material. Likewise, a groove can be cut in a material and filled with powder having a mixture of elements and then friction stir processed to mix the materials together.

Alternatively, material can be added directly to the surface of the material, or it can be sandwiched between two pieces of material such as steel, and then friction stir processed to join the materials together. Other methods can also be used to accomplish mixing of materials together in friction stir mixing.

When friction stir mixed, the powder is mixed with the base material by friction stir mixing to form a material having modified properties in the stir region. In selected embodiments, the process creates little heat generation and has low energy input, requires a very short time at temperature, will generally have fewer solidification defects, and can be fully automated. Advantageously, one or more embodiments need minimum post-processing inspection due to the solid state nature and extreme repeatability of the processing.

The processing method is tolerant to interface gaps and as such little pre-processing preparation, there is no material spatter to remove. The post-processing surface finish can be exceptionally smooth in selected embodiments with very little to no flash. Unlike other processes, the friction stir processing performed in accordance with some embodiments of the present invention can be done with little to no porosity, oxygen contamination, or distortion. Furthermore, friction stir processing can be performed in a controlled gas or liquid environment.

Elements, alloys, metals, and or other material types can be processed in solid form, powder form, fiber form, plate form, as wire, or in a series of composite compositions. In some embodiments, new materials can now be designed without concern for liquid phase problems.

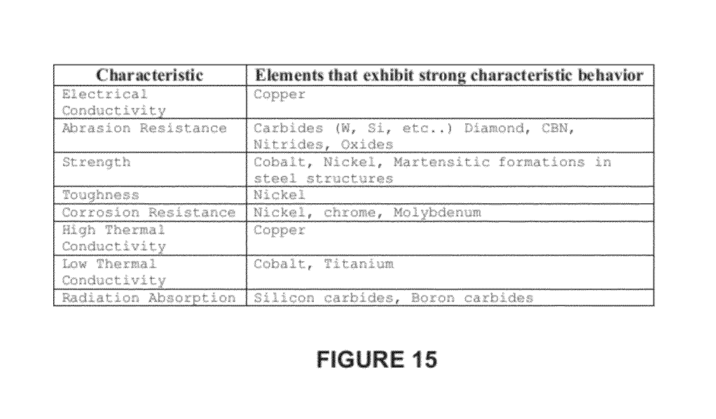

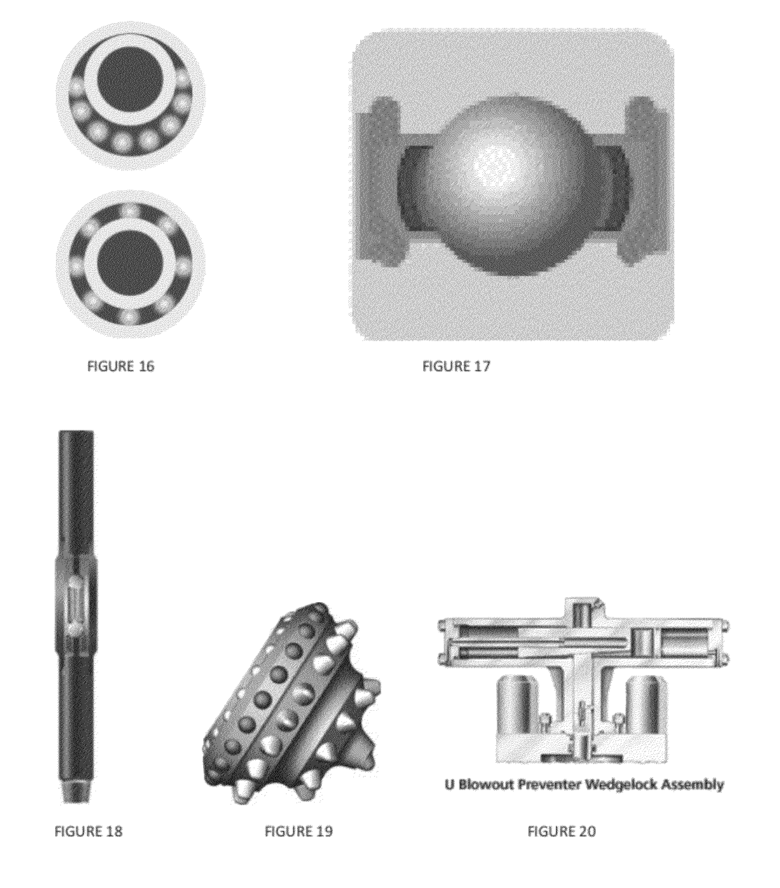

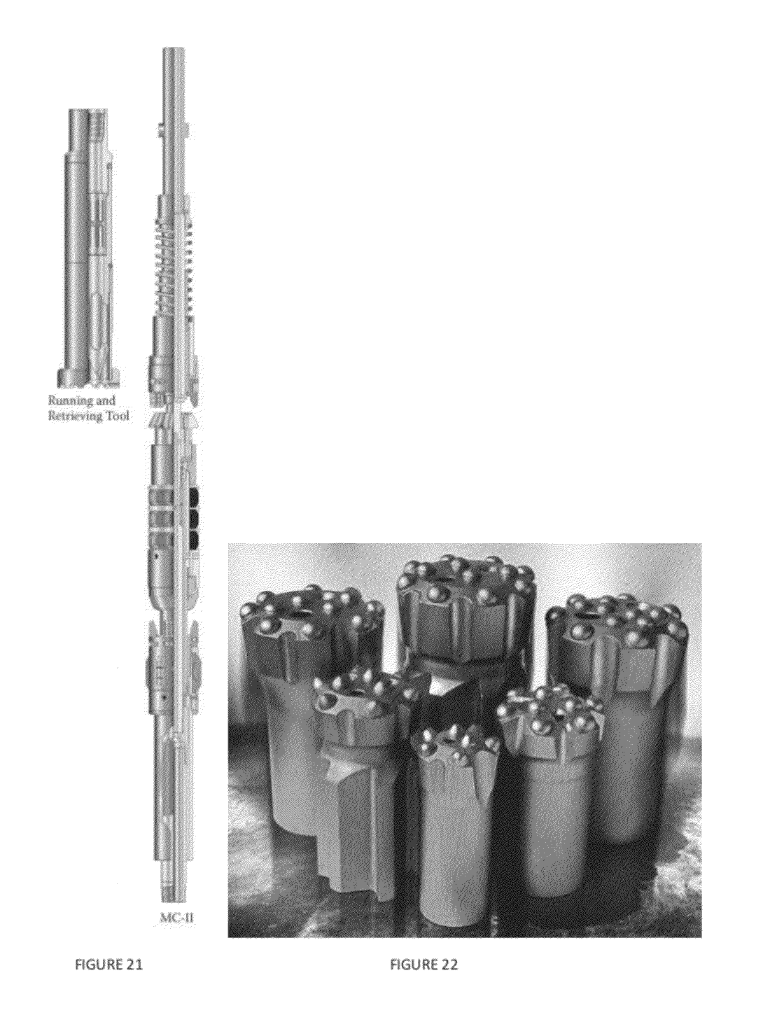

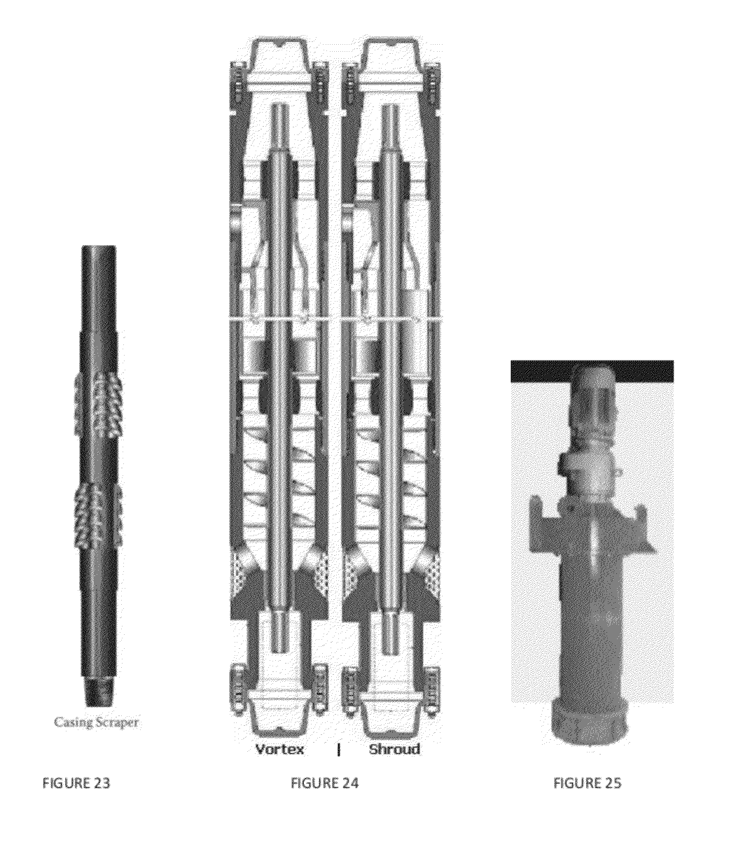

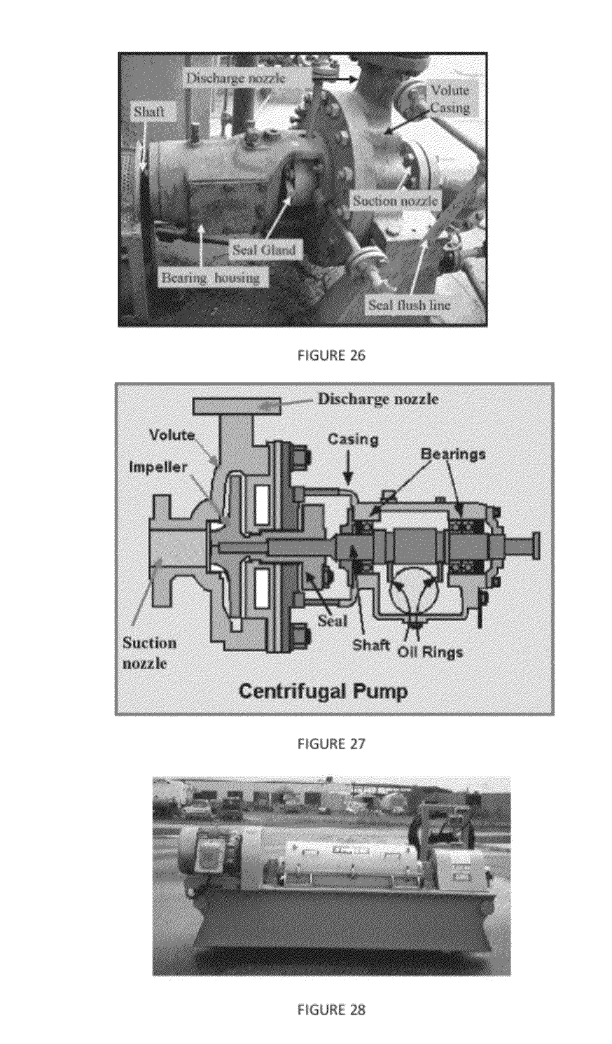

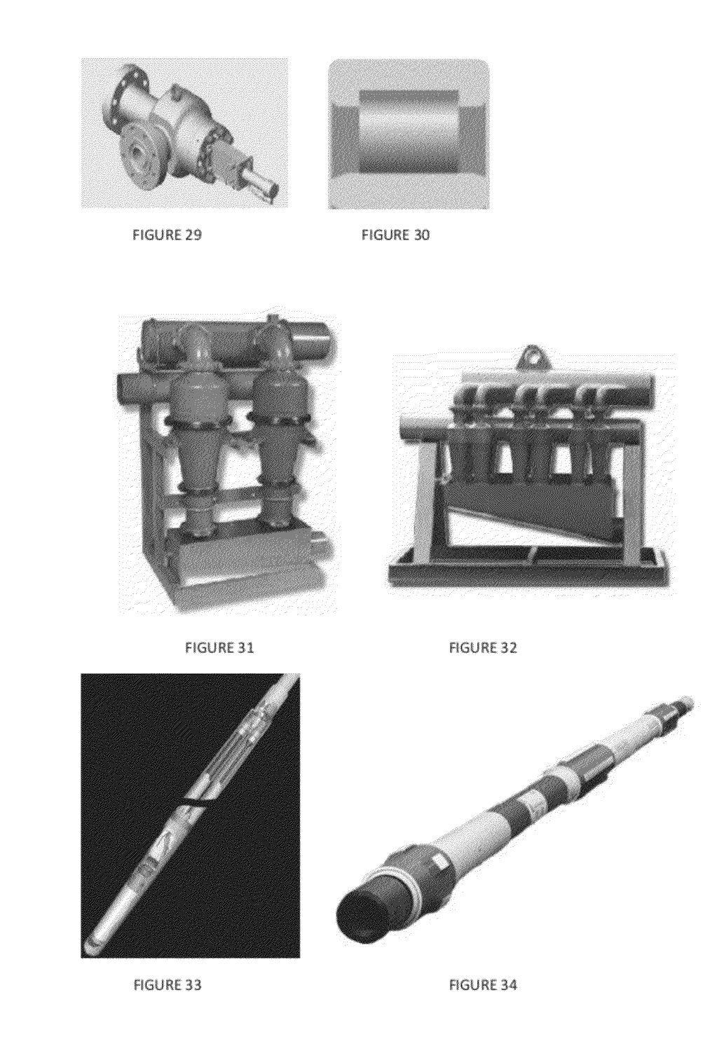

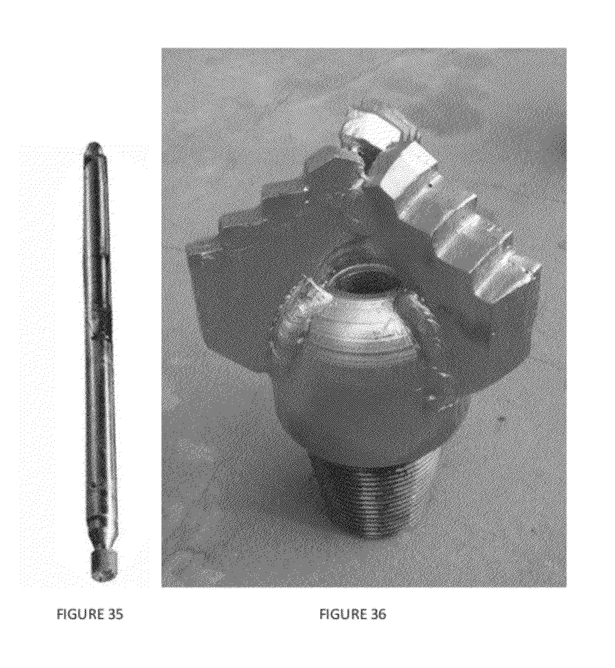

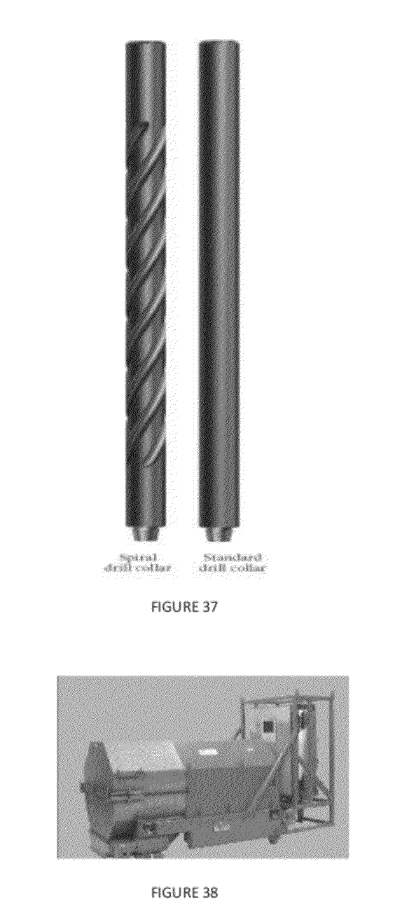

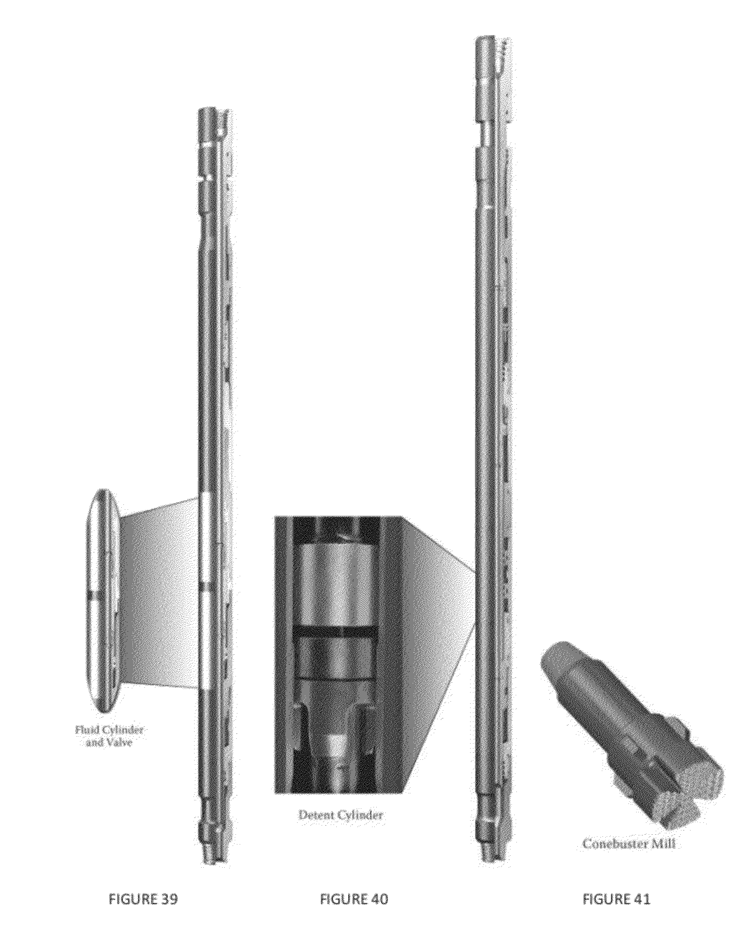

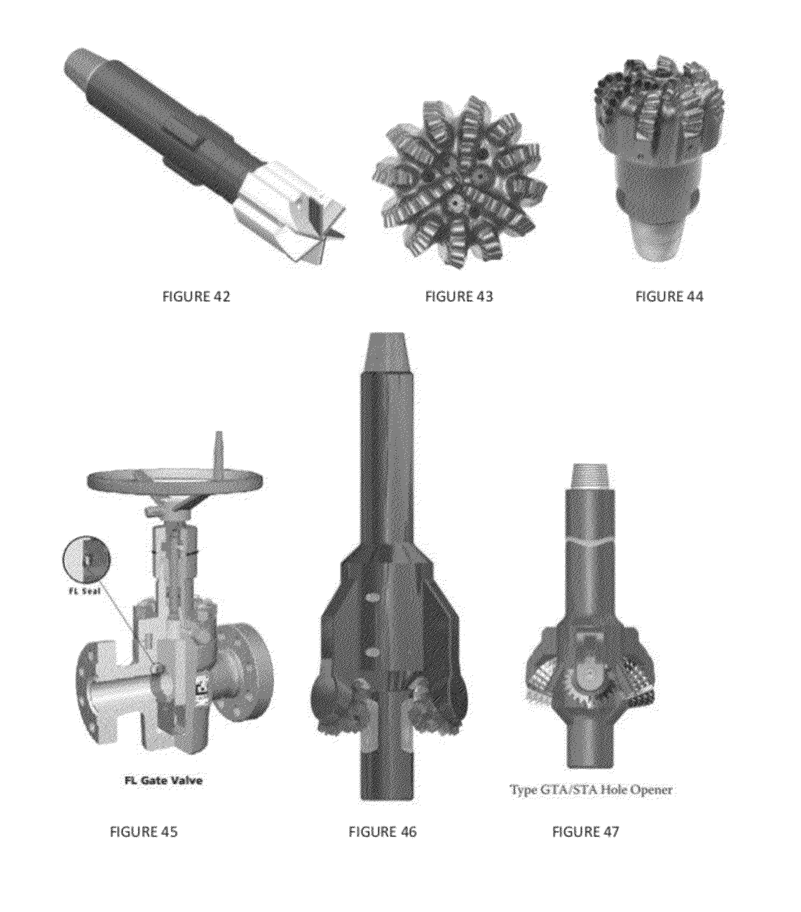

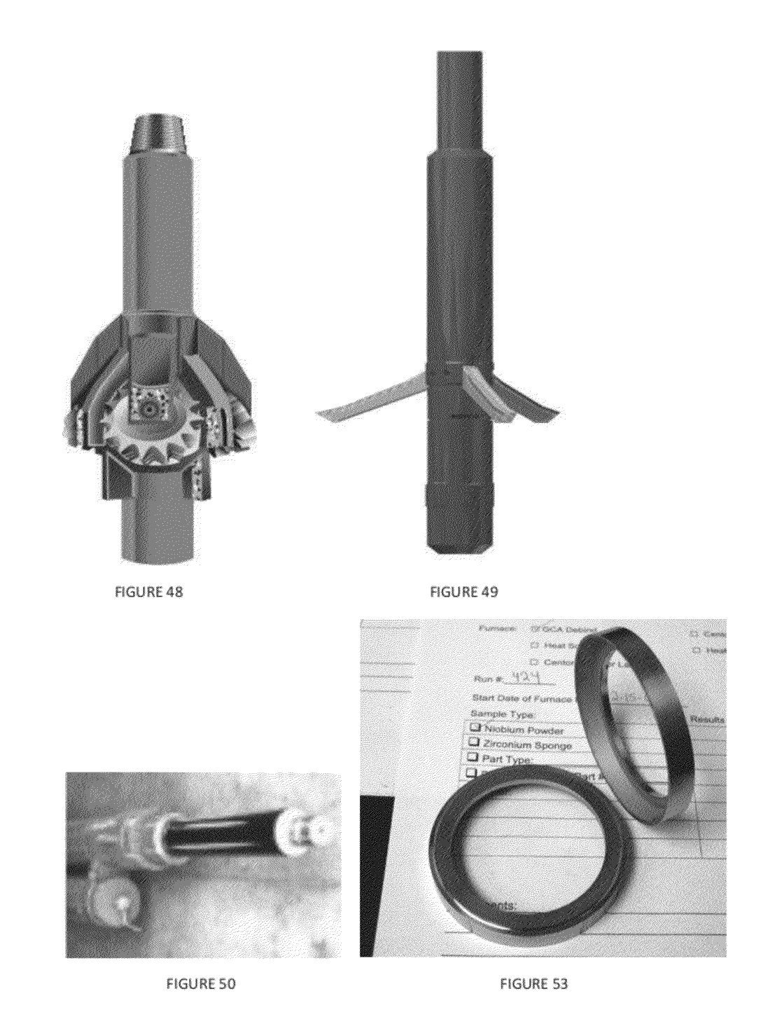

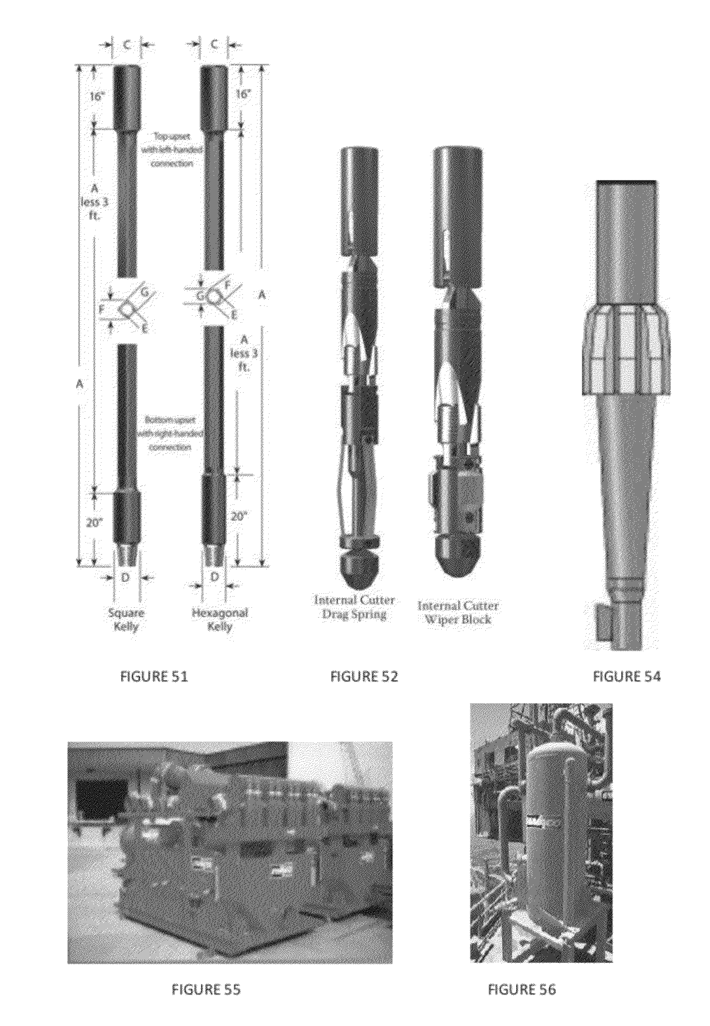

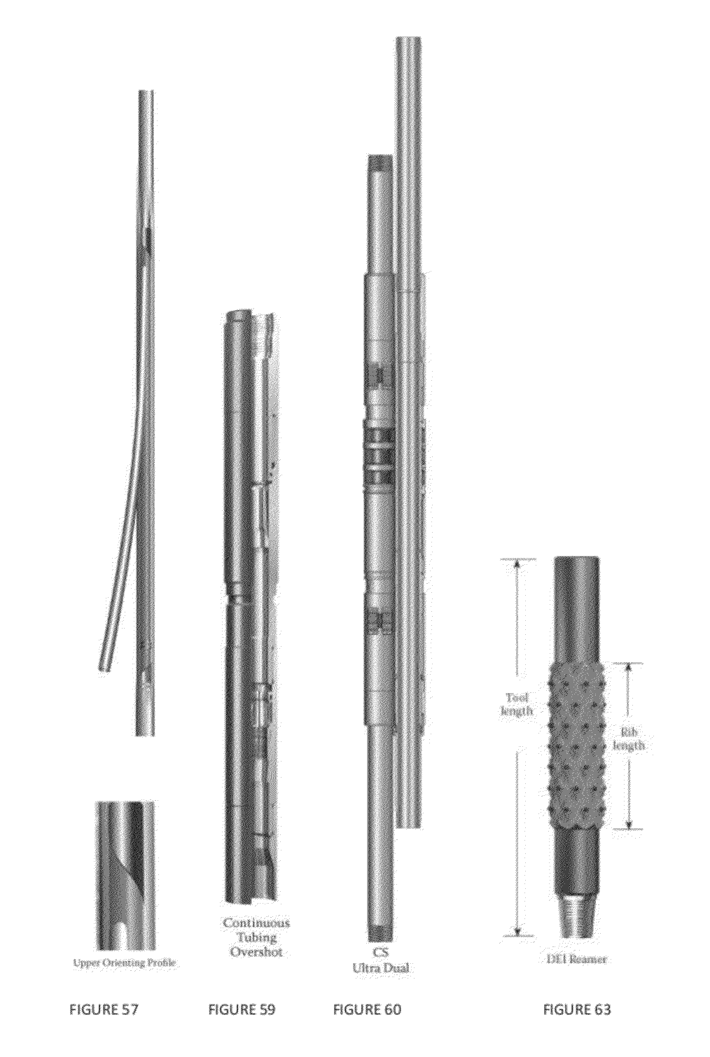

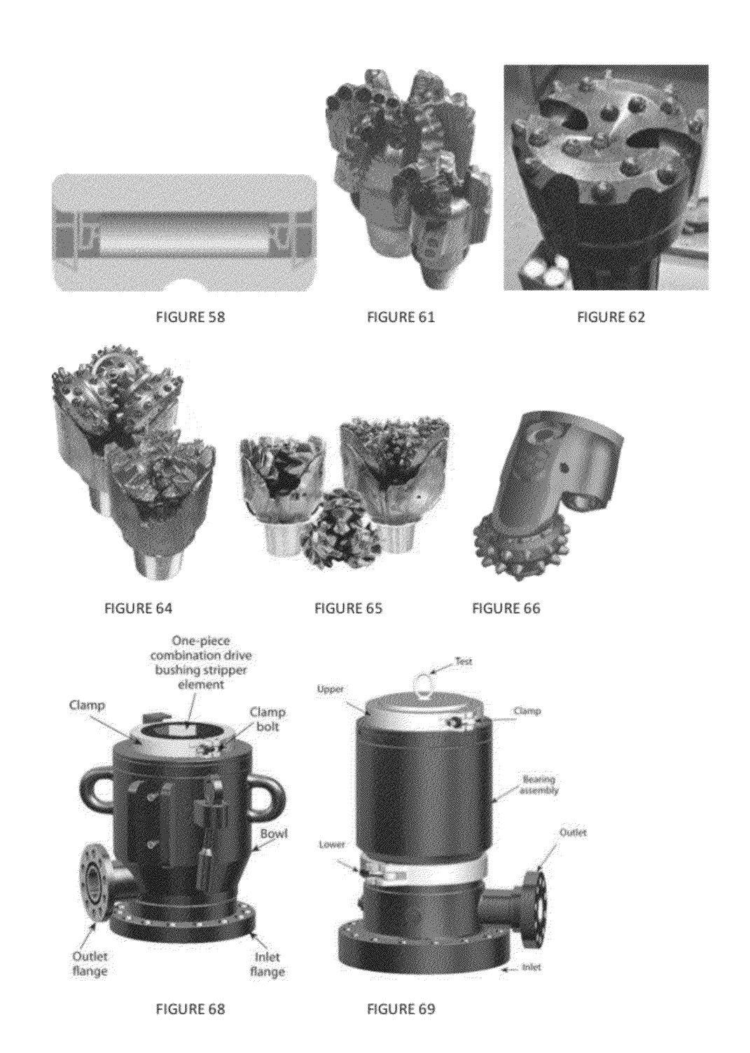

FIG. 15 shows some examples of how material characteristics for steels and other base materials can be affected by friction stir processing or friction stir mixing additive materials in.

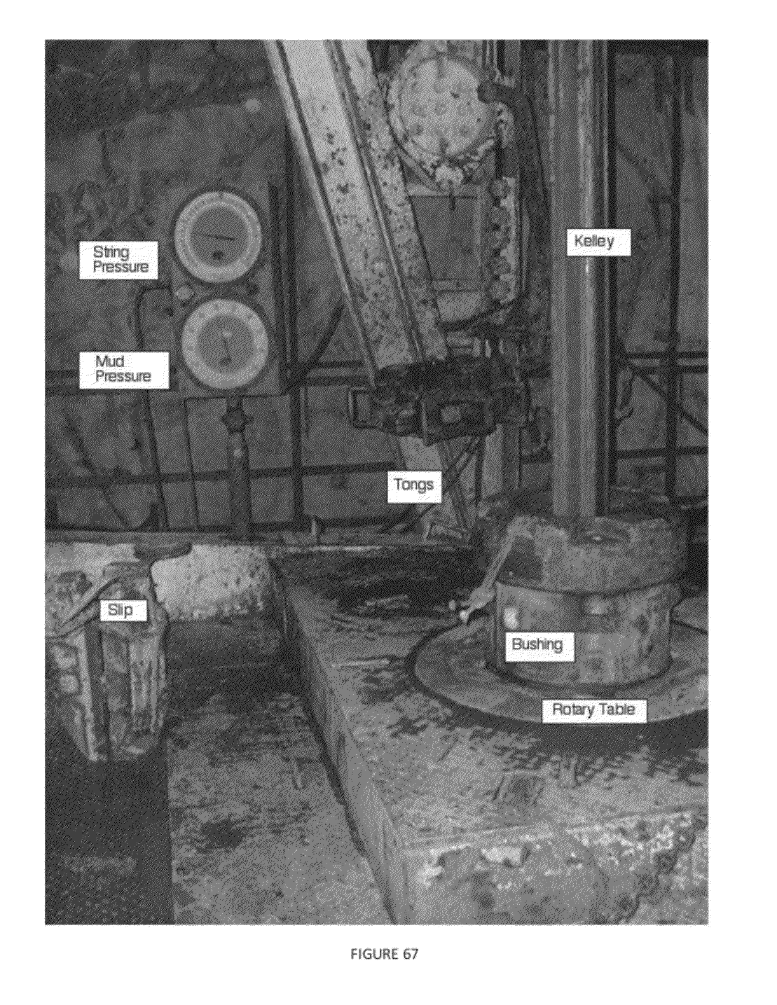

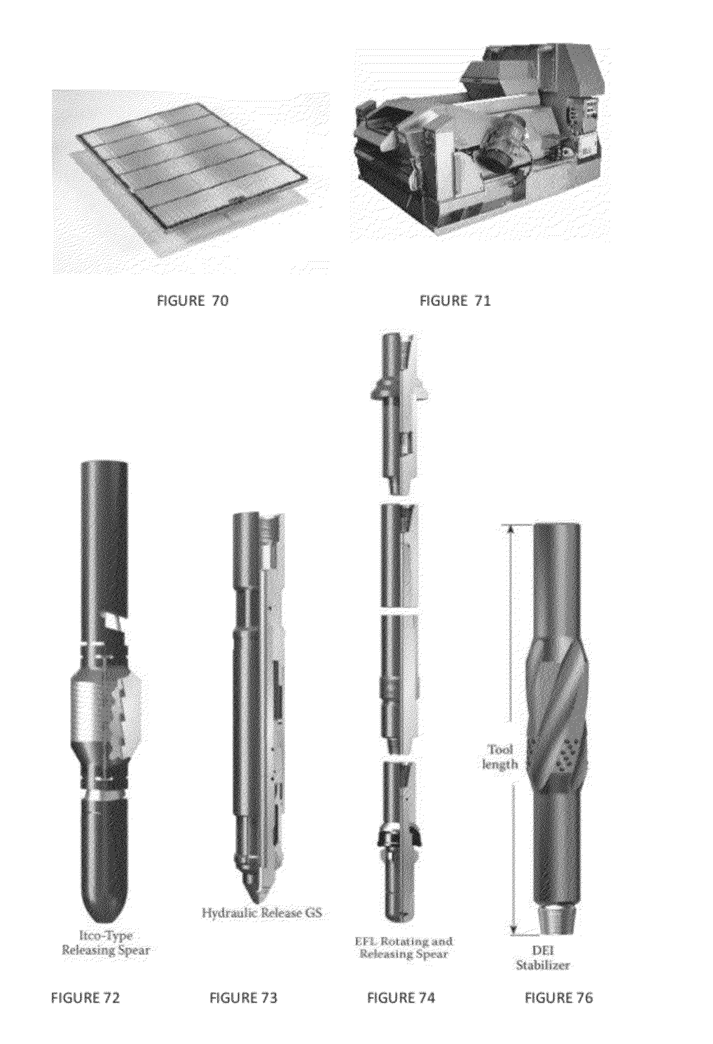

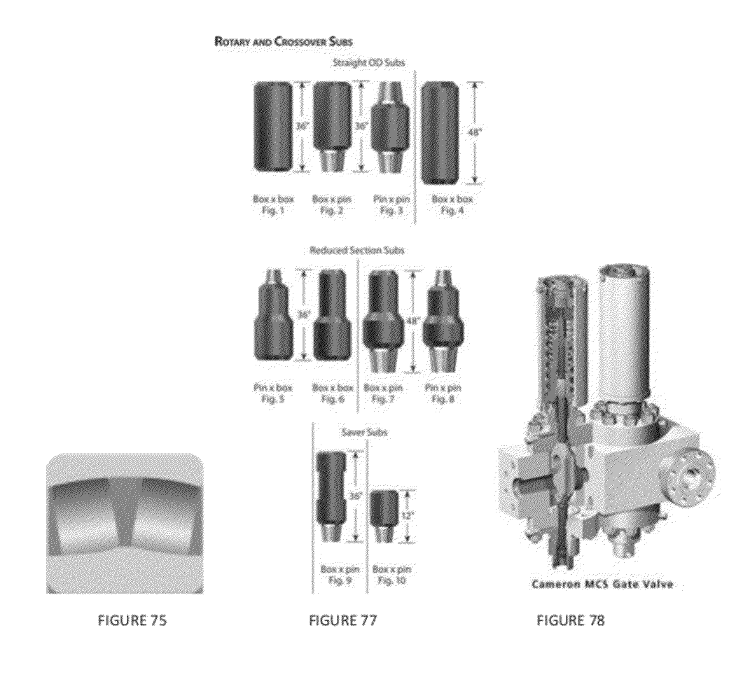

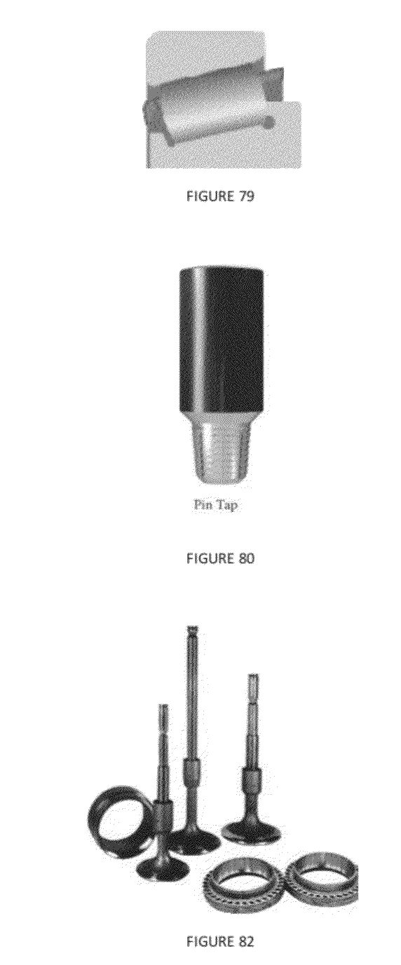

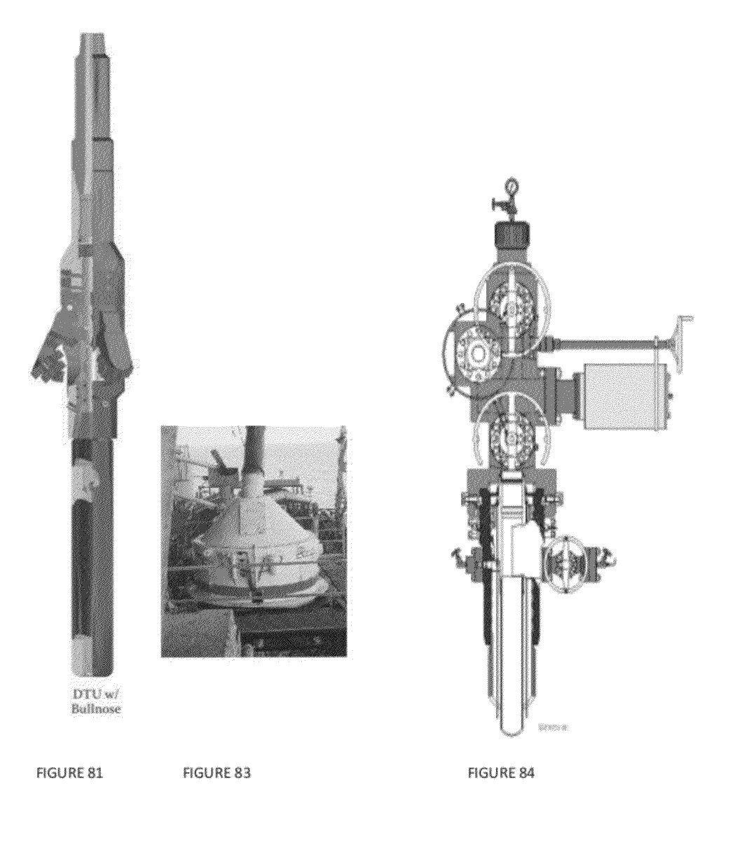

FIGS. 16 through 84 are illustrations showing equipment, tools, or components that the inventors have identified as benefiting from application of friction stirring in accordance with aspects of the present invention. In other words, by friction stirring (i.e., friction stir welding, friction stir processing, or friction stir mixing) surfaces or surfaces and sub-surfaces of materials used to form components or parts of tools or equipment in industrial applications, significant material, mechanical, performance and/or cost benefits can be achieved over the prior art as described above.

Those, skilled in the art will appreciate that for smaller components or parts considered for friction string, precision friction stirring tools can be developed and used. For example, smaller pin configurations may be used to treat or penetrate surfaces of smaller items or to providing friction stirring along restricted paths where a very specific area of interest is to be treated.

The items illustrated in FIGS. 16 through 84 include, in alphabetic order, a ball bearing and ball bearing race, a bearing reamer, a bit-insert roller cone, a blow-out preventor, a bridge plug, a button bit, a casing scraper, a centrifugal pump, a centrifugal degasser, a centrifuge to process drilling, completion and workover fluids, a choke, a cylindrical bearing, a desander, a desilter, a diaphragm pump, a vein pump, a downhole drilling motor-mud motor, a downhole turbine motor, a drag bit, a drill collar, a duster dryer, a fishing jar, a fishing milling cutter, a fixed cutter bit, a gate valve, a hole opener, a hole enlarger, a hydraulic pipe cutter, a hydraulic piston, a kelly, drill pipe, a mechanical casing cutter, a metal to metal seal, a mill starter, a mud cleaner, a mud-gas separator, a multilateral junction, a needle bearing, an overshot, a packer, a PDC bit, a percussion bit, a reamer, a roller cone bit, a roller cone bit showing a ball hole plug and a journal bearing, a roller cone bit leg, a rotary table, a rotating drill head, screens, a shaker, a spear, a spherical bearing, a stabilizer, subs, a subsea gate valve, a tapered bearing, taps, an under reamer, valves and seals, a cuttings dryer, and a well-head Christmas tree. No importance should be given to the order in which the items are shown.

Other applications are found in the construction industry. Specifically, many pieces of heavy equipment or equipment used in cutting, drilling, moving and any other aspect of construction or mining work can also benefit from the embodiments of the present invention. A few examples include the blade on a bulldozer, an asphalt remover, and long-wall mining equipment. The list above is indicative of the extreme diversity of applications of the present invention.

While the lists above are certainly extensive, they are not and should not be considered to be limited only to those items specifically identified. There are other pieces of equipment and components that may be found to perform similar functions that can also benefit from the friction stirring of the component itself, the surface of the component, or just a portion of the component or the surface thereof.

In view of the various examples and descriptions provided above as well as other documents incorporated by reference, it will be apparent to those skilled in the art that aspects associated with the present invention may be applied to any cutting blades, sealing surfaces, bearing surfaces, wear surfaces, and impact surfaces of components, parts, tools, and equipment noted above, shown in the figures, or known in the art to include such elements or surfaces. In one or more embodiments, such surfaces or elements are formed of metal matrix composites, ferrous alloys such as steel and stainless steel, and non-ferrous materials, superalloys, nickel, iron-nickel, and cobalt-based alloys, chromium, molybdenum, tungsten, aluminum, titanium, niobium, tantalum, and rhenium, and processed using one or more methods described above.

Some examples illustrating details of particular embodiments are provided as follows. Seal life and performance can be a limiting factor in roller cone bit life. When the seal fails, the bearing systems are subjected to the dynamic environment of mud and other contaminants. Once this occurs, bearing failure is imminent and rapid. Roller cone bit seals are traditionally made of rubber. A significant drawback of the standard rubber seal is that it is a static seal in a dynamic environment. It is desirable to have enough elasticity within the rubber material so that the seal can be installed in compression. This enables the rubber seal to expand but continue to provide a seal as the seal material wears away.

Seals are also a high friction component. For example, a metal-to-metal seal provides many properties that address the requirements of such a dynamic seal over that of a rubber-based seal that has improved wear resistance, low friction, compressibility, expandability, and thermal conductivity.

By using the new friction stir processing tool materials and designs, it is possible to create a solid state seal material using diamond and/or We-Co particles, or any of the elements, or use friction stir processing to condition the base material without disposing additives into it. Current and existing seal configurations can be modified and engineered by mixing different materials to achieve desired properties (i.e. hardness, toughness, thermal conductivity, friction, corrosion, etc.). The mix can use particles, grains, fibers, and/or any of the elements to create a new solid state seal material using friction stir processing methods. Grooves could be placed in the seal surface to act as a mold to hold the mixtures or starting powders to perform the solid state friction stir processing.

These new material seals (created from friction stir processing of the material by itself, or by mixing the material with We-Co, diamond, CBN additives) can be precision finished to tight specifications. The matched seals, such as those shown in FIG. 53, are then installed in a state of compression within the bit. The new material properties would be able to withstand high compression loads, and have a high thermal conductivity due to the diamond that was mixed into the seal material which enables rapid transfer of frictional heat away from the seal surface. In addition, the diamond and/or other elements that can be mixed into the seal material will have high wear resistance and lower friction which are desired properties. Even the original non-additive friction stir processed steel will have extremely high hardness and toughness.

Because the new seal material can withstand high compression and has high wear resistance, it should have an extended life. However, even when slight wear is experienced by the seal, the high compression of the material will allow for expansion during use, thus maintaining a tight seal.

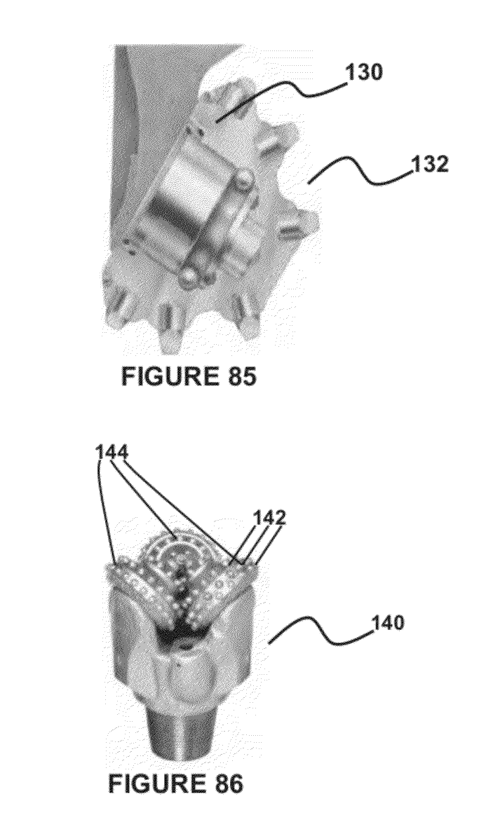

In addition to the metal-to-metal seal surfaces, there is another location that can benefit from an improved seal. Specifically, the seal gland area of the journal and steel roller cone bit can be friction stir processed. The seal gland area 130 is shown in FIG. 85. In the seal gland in a rotating cone on a roller cone bit, an elastomer seal or O-ring is typically compressed between the journal and the cone seal gland. These two concentric surfaces provide a minimum amount of contact pressure for a given amount of “squeeze” on the seal in the gland. For the first substantial portion of the operating lifetime of the bit (cone-journal) the sealing elements are compressed, between the surfaces, to withstand pressure differentials and prevent debris from entering the internal surfaces and bearing structures within the cone. After extended use the sealing element is degraded by wear and other factors, and the seal and sealing pressures deteriorate. Much of the lifetime of the gland-seal system is dependent upon the elastomer and gland wear.

With friction stir processing it is possible to shift the performance of the seal-gland system away from the elastomer seal to the mating surfaces that have been friction stir processed. The mating surfaces will now have extremely high wear resistance due to the changes in micro-structural properties. Rather than building precision gland and journal surfaces for an elastomer seal or wiper, the bulk cone material can be processed on both the journal and the internal cone surfaces and then subsequently machined as either mating surfaces to run against each other or to be prepared for an elastomer seal in the machined gland area. In both of these circumstances, the wear and toughness properties of the friction stir processed surfaces are improved, thereby giving longer life to the seal gland system or mating seal surfaces.

In an alternative embodiment, another method of accomplishing a similar result would be to externally friction stir process a hard metal sleeve set that can be machined and then fit into the cone and/or journal surfaces. This alternative embodiment will enable ease of fabrication and setups external to the cone and journal surface. More specifically, these systems would allow either gland areas for actual seals that extend the wear resistance of the glands or as mated surfaces that create a seal due to the very high wear resistance that results from the friction stir processed microstructures.

In these embodiments above, the friction stir processing can be extended beyond the seal gland area inside the cone to the outer skin or “heel” area of the cone resulting in strongly enhanced materials properties to further protect the cone and seal/gland areas from erosion and wear.

In FIG. 85, the cone 132 is utilizing a metal-to-metal seal system that has been friction stir processed as described above. The same process can be applied to achieve an improvement in performance and/or life cycle of the seal gland/wiper area as explained above.

In another example of the embodiments of the present invention, in many drilling applications where high speed, directional, and/or abrasive environment conditions exist, metal hard-facing is typically applied liberally to the shirt-tail portion of a roller cone bit leg and extends up to the leading edge of the bit leg to protect it from wear and eventual breakdown and wear of the internal seals and bearings. This hard-facing is usually made up of tungsten carbide particles. The problems associated with hard-facing are based on the cast structure that is formed. The cast structure results from a liquid phase that has solidified to hold in place hard particles required for abrasion resistance. The cast structure is subject to high residual stresses, solidification defects, and brittle composition of undesirable phases that precipitate into the solidified structure resulting in cracking, voids, and lack of adhesion to the base material.

By utilizing the new solid state friction stir processing of the material itself, or mixing in additives (diamond, WC-Co, and/or other elements) on the shirt-tails of the roller cone bits, a much tougher, more wear resistant, and more stress-free material can be achieved, and most likely at a lower cost.

In the embodiment where friction stir mixing is performed to put additives into a material, the starting powders could, for example, be deposited in a notch that is formed in the shirt-tail in the areas most in need of wear resistance, etc. Friction stir mixing would be used to create the new material for high wear resistance and protection of the shirt-tail area.

The examples described in the embodiment above have described the processing of components and surfaces of a roller cone bit. However, it is an aspect of the present invention that any surfaces or components on a diamond and/or PDC shear bit can be improved where erosion, wear, and/or toughness are issues in the life and breakdown of a bit. The principles of the present invention can be applied to areas such as fluid erosion areas on the surfaces of the bits, wear surfaces on the bits that are typically protected by use of gage pads, and nozzle areas to mention a few.

In addition, it is another aspect of the present invention that cutting structures used on both the roller cone bits and on the PDC bit could be enhanced by friction stir processing or friction stir mixing to maintain wear resistance and provide improved toughness.

For example, the present invention can be applied to enhance life cycle and/or performance of steel teeth 142 found on a mill tooth roller cone bit 140 as shown in FIG. 86. Instead of using the conventional manual hard-facing technique and material that is applied to the teeth of the mill tooth bit, the steel teeth 142 can be friction stir processed by them, or additives such as We-Co, diamond, CBN, and/or other elements could be mixed in using friction stir mixing.

It is observed that on the roller cone bit such as the one shown in FIG. 86, there are typically three rolling cones 144. All three of these cones 144 are made of steel. On the outside of the steel cones 144 there are either steel teeth 142 that are metal hard faced for high wear resistance or there are TCI (Tungsten Carbide Inserts) or DEI (Diamond Enhanced Inserts) used as the wear resistant teeth that are press-fit into holes drilled into the cone. The steel teeth 142 or TCI/DEI are the primary cutting and wear structures. These and all other areas of the steel cones 144 could benefit from friction stir processing or mixing. For example, the refined grain structure has high hardness and toughness to resist mechanical and erosion wear. The refined structure can hold particles, such as diamond, with greater strength than any solidified material (i.e. hard-facing second phase) that has formed a cast structure. Examples of areas that may benefit strongly from this surface processing would include the outer heel row of the steel cone as well as the steel cone areas between cutting structures where erosion and wear are experienced.

On the inside of the steel cones 144 are other surfaces used for ball, roller, or other bearing surfaces including races that would benefit from the new solid state FSP material and/or process. The internal moving and stationary systems and surfaces such as bearings, races, and seal surfaces could be improved significantly by taking advantage of the properties of the new solid state material and/or process (i.e. friction, thermal conductivity, wear resistance, etc.).

In another embodiment of the present invention, a cone is attached to each of three legs and journal bearings of a roller cone bit. On the outside of the shirt-tail area a hole is drilled in the leg to insert balls for the ball bearing design. These balls assist in the rotation and rolling of the each of the cones under tremendous torsional loads that are applied to the drill string. Once the balls are placed into the ball hole a plug is then inserted and welded in place to secure the ball bearing package. The weld joint at this location is of utmost importance. In fact, in many cases the “ball hole plug” has additional hard facing and even Wc-Co inserts and wear pads that are put around the ball hole plug weld to protect it from wear and erosion, which if it occurs, will allow the plug to fail and the bit will ultimately experience failure.

The ball hole plug can be secured using by friction stir processing or friction stir mixing to apply a coating with diamond and/or Wc-Co or other elements. In addition to providing a secure weld, friction stir processing and mixing provide a natural wear resistance to prevent abrasive and erosive wear due to the environment.

In another example, FIGS. 34 and 35 illustrate downhole motors that are used for drilling oil. There are turbine powered motors as shown in FIG. 35 and downhole mud motors shown in FIG. 34. Both of these types of motors are subjected to very harsh drilling conditions and environments. These motors use a series of components that are designed and engineered to resist wear, erosion, and corrosion due to these harsh environments. Such components are thrust bearings, turbine blades, rotors, stators, and impellers etc. Companies have been built for the sole purpose of improving drilling power efficiency and dependability and to extend the costly intervals between trips in wells of rapidly increasing depths and profile complexity.

Down hole turbine motors and mud motors have so many moving and working parts that depend on the properties of hardness, wear resistance, toughness, lubrication, corrosion resistance, friction, and stress management. The potential for any of these weak links to have the properties improved upon by the principles of the present invention is great. In many cases very expensive components may be replaced by means of the new material and process.

The examples of this document have concentrated on applications that are specific to not only the oil and gas industries, but to construction and materials processing as well. In addition, it is noted that there are many medical applications that can also benefit from the present invention.

For example, there are now implantable structures used to replace or reconstruct parts of the human body. If the lifetime of these structures can be increased so that no replacement is necessary within the lifetime of the human host, the trauma that is saved from the patient is tremendous. Any type of joint is a particularly useful application of the present invention. Often, these joints can experience severe stress or wear over their lifetime. These structures include, but should not be considered limited to hip joints, knee joints, ankle components, and shoulder joints.

It is to be understood that the above-described arrangements and embodiments are only illustrative of the application of the principles of the present invention. Numerous modifications and alternative arrangements may be devised by those skilled in the art without departing from the spirit and scope of the present invention. The appended claims are intended to cover such modifications and arrangements.

1. A method for manufacturing an apparatus to improve performance, reliability, or useful life thereof, said method comprising the steps of:
identifying at least one portion of the apparatus that experiences stress; and
friction stirring the at least one portion to thereby improve performance, reliability or useful life thereof by modifying the residual compressive stress of the at least one portion through contact with a rotating friction stirring spindle tool comprising a shank, a shoulder and a pin, by forming an area with increased residual compressive stress within the at least one portion as a result of the friction stirring by the rotating friction stirring spindle tool, wherein the friction stirring comprises plunging the pin of the rotating friction stirring spindle tool into the least one portion and transversely moving the rotating friction stirring spindle tool across the at least one portion to thereby impart increased residual compressive stress within the at least one portion.

2. The method as defined in claim 1 wherein the step of friction stirring is selected from the group of friction stirring processes including friction stir welding, friction stir processing, and friction stir mixing.

3. The method as defined in claim 2 wherein the apparatus is selected from the group of drilling tools and components including a drill bit, a roller cone drill bit, a bit insert roller cone, a button bit, a drag bit, a drill collar, a fishing milling cutter, a fixed cutter bit, a mechanical casing cutter, a percussion bit, a reamer, a ball hole plug, a journal bearing, a roller cone leg, a PDC bit, and a rotating drill head.

4. The method as defined in claim 2 wherein the apparatus is selected from the group of oil and gas equipment and components including a centrifugal pump, a centrifugal degasser, a choke, a desander, a desilter, a diaphragm and vein pump, a downhole drilling motor, a downhole mud motor, a downhole turbine motor, a gate valve, a hole opener, a hole enlarger, a hydraulic piston, a Kelly and drill pipe, a metal-to-metal seal, a mud cleaner, a mud-gas separator, a multilateral junction, an overshot, a packer, a screen, a shaker, a subsea gate valve, a stabilizer, a spear, a Blow-Out preventor and a well-head Christmas tree.

5. The method as defined in claim 2 wherein the apparatus is selected from the group of bearings and components including a ball bearing race, a cylindrical bearing, a needle bearing, a spherical bearing, and a tapered bearing.

6. The method as defined in claim 2 wherein the apparatus is selected from the group of tool surfaces including a heal surface, a cutting surface, an impact surface, a bearing surface, a sealing surface, and a journal surface.

7. The method as defined in claim 2 wherein the apparatus is a solid state metal-to-metal seal component for a metal-to-metal gap, said method comprising the step of processing the solid state metal-to-metal seal component so as to provide an elevated state of compression within the solid state metal-to-metal seal component.

8. The method as defined in claim 7 wherein the method further comprises the step of processing the solid state metal-to-metal seal component so as to provide high thermal conductivity to thereby enable rapid transfer of frictional heat away from a seal surface.

9. The method as defined in claim 7 wherein the method further comprises the step of processing the solid state metal-to-metal seal component so as to provide high wear resistance and lower friction between surfaces thereof.

10. The method as defined in claim 2 wherein the apparatus is selected from the group of medical implants including hip joints, knee joints, ankle components, and shoulder joints.

11-30. (canceled)

31. A method for modifying performance characteristics of an apparatus to thereby obtain an increase in performance, reliability, or useful life thereof through friction stirring, said method comprising the steps of:
1) identifying at least one area of the apparatus that can be modified to increase performance, reliability, or useful life;
2) friction stirring the apparatus to thereby modify at least one characteristic thereof to thereby increase performance, reliability, or useful life of the apparatus.

32. The method as defined in claim 31 wherein the method further comprises the step of causing a substantially solid state transformation without passing though a liquid state of the apparatus.

33. The method as defined in claim 31 wherein the method further comprises the step of using a high melting temperature material for the apparatus.

34. The method as defined in claim 31 wherein the method further comprises the step of selecting the high melting temperature material for the apparatus from the group of high melting temperature materials including ferrous alloys, non-ferrous materials, superalloys, titanium, cobalt alloys typically used for hard facing, and air hardened or high speed steels.

35. The method as defined in claim 32 wherein the method further comprises the step of synthesizing a new material having at least one different characteristic from the apparatus.

36. The method as defined in claim 31 wherein the method further comprises the steps of:
3) providing an additive material; and
4) friction stir mixing an additive material into the apparatus to thereby modify at least one characteristic of the apparatus.

37. The method as defined in claim 31 wherein the method further comprises the step of modifying a microstructure of the apparatus to thereby increase the performance, reliability, or useful life thereof.

38. The method as defined in claim 37 wherein the method further comprises the step of modifying a macrostructure of the apparatus to thereby increase the performance, reliability, or useful life thereof.

39. The method as defined in claim 37 wherein the step of modifying the microstructure includes increasing toughness of the apparatus to thereby increase the performance, reliability, or useful life thereof.

40. The method as defined in claim 37 wherein the step of modifying the microstructure includes increasing or decreasing hardness of the apparatus to thereby increase the performance, reliability, or useful life thereof.

41. The method as defined in claim 37 wherein the step of modifying the microstructure includes modifying grain boundaries of the apparatus to thereby increase the performance, reliability, or useful life thereof.

42. The method as defined in claim 37 wherein the step of modifying the microstructure includes decreasing grain size of the apparatus to thereby increase the performance, reliability, or useful life thereof.

43. The method as defined in claim 37 wherein the step of modifying the microstructure includes modifying distribution of phases of the apparatus to thereby increase the performance, reliability, or useful life thereof.

44. The method as defined in claim 37 wherein the step of modifying the microstructure includes modifying ductility of the apparatus to thereby increase the performance, reliability, or useful life thereof.

45. The method as defined in claim 37 wherein the step of modifying the microstructure includes modifying superplasticity of the apparatus to thereby increase the performance, reliability, or useful life thereof.

46. The method as defined in claim 37 wherein the step of modifying the microstructure includes increasing nucleation site densities of the apparatus to thereby increase the performance, reliability, or useful life thereof.

47. The method as defined in claim 37 wherein the step of modifying the microstructure includes modifying compressibility of the apparatus to thereby increase the performance, reliability, or useful life thereof.

48. The method as defined in claim 37 wherein the step of modifying the microstructure includes modifying ductility of the apparatus to thereby increase the performance, reliability, or useful life thereof.

49. The method as defined in claim 37 wherein the step of modifying the microstructure includes modifying the coefficient of friction of the apparatus to thereby increase the performance, reliability, or useful life thereof.

50. The method as defined in claim 37 wherein the step of modifying the microstructure includes increasing or decreasing thermal conductivity of the apparatus to thereby increase the performance, reliability, or useful life thereof.

51. The method as defined in claim 37 wherein the step of modifying the microstructure includes increasing abrasion resistance of the apparatus to thereby increase the performance, reliability, or useful life thereof.

52. The method as defined in claim 37 wherein the step of modifying the microstructure includes increasing corrosion resistance of the apparatus to thereby increase the performance, reliability, or useful life thereof.

53. The method as defined in claim 37 wherein the step of modifying the microstructure includes modifying magnetic properties of the apparatus to thereby increase the performance, reliability, or useful life thereof.
